(19) United States
(12) Patent Application Publication
(10) Pub. No.: US 2003/0078833 A1
(43) Pub. Date: Apr. 24, 2003

(54) Marketing supporting method and device using electronic message

(76) Inventors: Yoshihiko Suzuki, Shinagawa-ku Tokyo (JP); Takumi Morita, Nerima-ku Tokyo (JP)

Correspondence Address: BELL, BOYD & LLOYD, LLC, P. O. BOX 1135, CHICAGO, IL, 60690-1135, US

(21) Appl. No.: 10/258,242

(22) PCT Filed: Apr. 20, 2001
(86) PCT No.: PCT/JP01/03426

(51) Int. Cl. G06F 17/60

(52) U.S. Cl. 705/10; 705/9; 705/14

(57) ABSTRACT

By client's selectively registering a salesperson, a support server (1) for permission marketing is provided where a salesperson whom a client approved achieves one-on-one communications with the client. When the client enters an identifying code of the salesperson in the support server (1), entry of the client is registered into a client list of the salesperson. The salesperson prepares a message addressed to a client registered in the client list file. A catch image based on a catch phrase or an image of the salesperson can be associated with the message. The prepared message to be addressed to the client is sent to the support server (1) and is stored in a message database (330). When the client accesses to the support server by using a browser, a message addressed to the client is read out, and an image for guiding a message from a salesperson whom the client approved of is displayed. When the client clicks on the guidance image, messages can be read and information linked to the guidance image can be browsed, and so forth.

### TECHNICAL FIELD

The present invention relates to a marketing supporting method by which to present information to clients. It particularly relates to a permission marketing technology where the client approves a salesperson by selectively registering the salesperson and the salesperson approved by the client can achieve one-on-one communications with the client.

### BACKGROUND TECHNOLOGY

Since advertisements by direct mail, magazines, TV and so forth are information distributed unilaterally without the consent of customers, there is no way of checking on the reaction of the customers to the advertising, and it is not easy to see whether the customers have judged the advertisement of any value to them or not. In electronic commercial transactions over the Internet, a new concept is taking form in which acceptance of an advertisement by customers when they receive the advertised information is taken as a measure of the effect of the advertisement. In electronic commercial transactions, it has been practiced that the extent of acceptance by the customers is used in the judgment of success or failure of marketing and the marketing strategy is pursued in consideration of the acceptance of the customers. For example, mail magazines distributed by electronic mail have realized a system in which only information permitted by the customers is distributed to the customers by having them register the subjects of their interest in advance or select mail magazines that offer information they are interested in. Moreover, the portal sites that provide Web pages individually customized for customers according to their customer profiles are another example of marketing method based on the permission of customers.

This kind of marketing based on the permission of customers is called “permission marketing.” The permission marketing, however, is not something devised for the first time in the commercial transactions on the Internet. It can be said that the marketing strategy based on the permission of customers has been used conventionally in sales activities where salespeople, such as dealers or door-to-door salespersons, conduct sales face to face with their customers. However, the face-to-face selling is a marketing strategy that requires much time and cost, thus, there is much demand that the Internet be put to use in supporting the person-to-person sales.

In the medical industries, for instance, an increasing number of foreign-affiliated pharmaceutical enterprises are launching their own sales systems in part because the pharmaceutical market of Japan has grown to be second in the world next only to America. When they take up their own sales systems, their business and sales activities need to be expanded by increasing their sales personnel, which entails an increase in personnel expenses and system operation cost. Yet, there is a merit where a consistent system ranging from production to sales on their own can be structured and the identity of an enterprise is likely to be brought into full play. As these foreign-affiliated pharmaceutical enterprises increase their sales personnel, however, domestic pharmaceutical enterprises cannot help increasing their sales personnel as well. However, the increase of sales personnel causes an increase in personnel expenses. Also, because doctors and medical researchers, who are their customers, are often busy, the chances are limited for the sales personnel to directly meet them and talk with them. So, the efficiency of personal solicitation is extremely low. Thus, since the chances are increasing where people engaged in medical services, too, collect medical information on the Internet, many pharmaceutical enterprises have been expressing their desire to have their own business support system built that enables the sales personnel of the pharmaceutical enterprises to approach their customers on the Internet.

### DISCLOSURE OF THE INVENTION

Therefore, an object of the present invention is to provide a technology of permission marketing in which a salesperson can achieve one-on-one communication with a client and the service close to door-to-door selling can be provided to the client by a further efficient method.

A mode of the present invention relates to a marketing supporting method. This method includes: receiving an input of personal data of a client so as to be stored in a client table; receiving an input of personal data of a salesperson so as to be stored in a salesperson table; receiving identifying data of a salesperson in order for the client to approve the salesperson; generating a selective registration table which, based on the identifying data that a client has inputted, associates the client table of the client with the salesperson table of an approved salesperson; and registering entry of the client into a client list file of the approved salesperson, on the occasion of the generating the selective registration table, so as to enable preparation of a message to said client. Here, the client list file may be provided separately from the selective registration table, and the selective registration table may serve as the client list file.

In the present specifications, terms such as “business” and “marketing” are used in the broad sense including advertisement, marketing research, information service, solicitation, sales and so forth. In the case of “salesperson” used, it includes not only a person who advertises and sells products and services to clients but also an information provider and a consultant who provide the clients with beneficial information.

The method may further include registering into a salesperson list file of the client an entry of a salesperson whom the customer approved of, on the occasion of the generating of the selective registration table, so as to enable preparation of a message from the client to the salesperson.

The method may further include: receiving the client's canceling registration of the salesperson; notifying the salesperson whose registration was canceled, to the effect that registration has been canceled by the client; disabling the selective registration table that associated the salesperson table of the salesperson whose registration was canceled, with the salesperson table of the client who carried out the cancellation; and deleting an entry of the client who carried out the cancellation, from the client list file of the salesperson whose registration was canceled, on the occasion of the disabling the selective registration table. The disabling of the selective registration table may be achieved by deleting the selective registration table or by setting a disable flag in the selective registration table.

The registering entry of the client may be such that in the selective registration table there is provided an entry into which the salesperson in charge of the client can input a note regarding the client, and the table is supplied as the client list file of the salesperson. At least part of entry of the selective registration table may be used for client's personal data stored in the client table. As an entry for the note, there may be provided an entry which sets importance of the client.

The registering entry of the salesperson may be such that a salesperson's profile stored in the salesperson table of a salesperson whom a client approved is included in the entry of the salesperson so as to be registered into the salesperson list file of the client.

Another mode of the present invention relates also to a marketing supporting method. This method includes: receiving an input of personal data of a client so as to be stored in a client table; receiving an input of personal data of a salesperson so as to be stored in a salesperson table; receiving identifying data of a salesperson in order for the client to approve the salesperson; generating a selective registration table which, based on the identifying data that a client has inputted, associates the client table of the client with the salesperson table of an approved salesperson; registering entry of the client into a client list file of the approved salesperson, on the occasion of the generating the selective registration table, so as to enable preparation of a message to said client; and supporting to compose a message to be sent to a client registered in the customer list file by providing the salesperson with a formal library, prepared in advance, for use with business. The formal library includes promotional advertisements of products, business-used fixed-form sentences and so forth.

The supporting may be such that, in order to display an image for guiding the message on a client terminal, there is provided an interface which prepares the guidance image, and an input of a catch phrase which appears in the image is received.

The supporting may be such that, in order to display an image for guiding the message on a client terminal, there is provided an interface which prepares the guidance image, and setting of a personal image of the salesperson which appears in the image is received.

The supporting may further include receiving setting of expiration date of the message from the salesperson, and disabling a message whose expiration date has passed in order for the message not to be displayed on a client-side terminal.

Another mode of the present invention relates also to a marketing supporting method. This method includes: receiving an input of personal data of a client so as to be stored in a client table; receiving an input of personal data of a salesperson so as to be stored in a salesperson table; receiving identifying data of a salesperson in order for the client to approve the salesperson; generating a selective registration table which, based on the identifying data that a client has inputted, associates the client table of the client with the salesperson table of an approved salesperson; registering entry of the client into a client list file of the approved salesperson, on the occasion of the generating the selective registration table, so as to enable preparation of a message to the client; and displaying an image that guides a message from a salesperson whom the client approved of, on a screen of a terminal of the client. This displaying may be structured such that page data are so structured that the message guiding message is to be displayed on a terminal of the client and supplied to a browser of the client's terminal.

The displaying may be such that, upon receipt of setting of priority for a plurality of salespersons whom the client approved of, guidance of a message of the salesperson is image-displayed in accordance with the priority. A guidance image for this message may be banner image displayed by the browser of the client's terminal.

The displaying may be such that guidance of a message of a salesperson whose priority is high is image-displayed while a message of a salesperson whose priority is low is displayed in a listed manner in accordance with an instruction from the client. The displaying may be controlled in a such manner that a message whose expiration date has passed is not displayed. The displaying may be such that an image which guides a message from a salesperson is displayed by utilizing a personal image of the salesperson.

The displaying may be such that, when there is no unread messages from the salesperson, profile for the salesperson's company is image-displayed in place of message guidance. The image for this company profile may be a logotype of the company or a banner advertisement of the company.

The method may further include, in the event that the guidance image is clicked by the client, displaying a message associated with the image. The method may further include, in the event that the guidance image is clicked by the customer, switching an accessing site of the client to a link site associated with the image so as to display information of the link site. Data to be associated with the guidance image is not limited to the message prepared by the salesperson, and may be a URL that indicates a link site address of the Internet.

Still another mode of the present invention relates also to a marketing supporting method. This method includes: receiving an input of personal data of a client so as to be stored in a client table; receiving an input of personal data of a salesperson so as to be stored in a salesperson table; receiving identifying data of a salesperson in order for the client to approve the salesperson; generating a selective registration table which, based on the identifying data that a client has inputted, associates the client table of the customer with the salesperson table of an approved salesperson; registering entry of the customer into a client list file of the approved salesperson, on the occasion of the generating the selective registration table, so as to enable preparation of a message to the client; and storing status of each message by unitarily managing messages that the salesperson sent to a plurality of clients registered in the client list file. The status of message includes date and time of message transmission, a flag indicating a read/unread state of message by a client, date and time of message opening, date and time of deletion, date and time of saving and so forth.

The method may further include: notifying the salesperson about the status of the message; and receiving from the salesperson a request that an unread message be canceled. The method may further include, in the event that the salesperson requested that already read messages be canceled, refusing the cancellation request.

The method may further include suggesting an action that the salesperson should take for the client, based on the status. The suggesting the action may be such that a content of the action to be taken for the client is determined based on whether or not a message sent from the salesperson to the client is unread or the number of days elapsed after the client read the message when the message is already read. The suggesting the action may be such that a content of the action is determined based on, among a plurality of messages that the salesperson sent to the client, at least one of the number of messages in a state of being unread and the number of days elapsed after a most recent day when the client read a plurality of the messages. The suggesting the action may be such that a plurality of decision criteria for actions are set up in correspondence to importance levels of clients, and a content of the action is determined based on a decision criterion suited for an importance level.

The method may further include evaluating performance of the salesperson in accordance with status of contact with clients registered in the client list file. The evaluating performance may be such that performance of the salesperson is evaluated based on at least one of the number of clients registered in the client list file, the number of messages sent to clients and a ratio at which messages sent to clients are read by the clients. The storing status is such that the statuses of messages a plurality of salespersons sent to their own clients whom the plurality of salespersons are in charge of are unitarily managed, and the evaluating performance may be such that performance of the plurality of salespersons is compared and evaluated.

Still another mode of the present invention relates to a marketing supporting apparatus. It includes: a client database which stores a client table that inputs personal data of a client; a salesperson database which stores a salesperson table that inputs personal data of a salesperson and a selective registration table that associates the client table with the salesperson table; a selective registration unit which receives, from a client, registration of identifying data of a salesperson whom the client approves; a salesperson-side message interface which supports preparation of a message addressed to the client from the salesperson; a message database which stores the message addressed to the client; and a client-side message interface which provides the client with the message addressed to the client via a network, by reading out the message from said message database, wherein, when the registration of the identifying data of the salesperson is received from the client, the selective registration unit generates and stores the selective registration table which associates the salesperson table of the salesperson identified by the identifying data with the client table of the client who performed the registration, and the salesperson-side message interface, on the occasion of generation of the selective registration table, enables preparation of a message to the client who performed the registration.

The message database may be a single database structured such that the salesperson and the client can read and write messages by commonly accessing thereto via the salesperson-side message interface and the customer-side message interface, respectively.

The message database may be structured such that status of message by client is recorded in units of message, based on sender ID's and receiver ID's recorded in a header portion of message, and the salesperson can unitarily read messages belonging to a plurality of clients whom the salesperson himself/herself is in charge of, together with the status thereof.

It is to be noted that any arbitrary combination of the above-described elements and their expressions changed between a method, an apparatus, a recording medium, computer program and so forth are also encompassed by the's cope of the present invention.

### BRIEF DESCRIPTION OF THE DRAWINGS

The above-described objects and the other objects, features and advantages will become more apparent from the following preferred embodiments taken with the accompanying drawings in which:

FIG. 1 shows a structure of an MR support system according to an embodiment.

FIG. 2 shows a functional structure of an MR support server in the MR support system shown in FIG. 1.

FIG. 3 illustrates data structures of an MR table, a selective registration table and a client table included in a database of the MR server shown in FIG. 2 and reference relations between them.

FIG. 4 illustrates data structures of a message header record, a message body record, a catch image record and a reached call log record included in the database of the MR server shown in FIG. 2, and reference relations between them.

FIG. 5 is a flowchart explaining processings in the MR support server shown in FIG. 2.

FIG. 6 illustrates a screen displayed on a user terminal in the MR support system shown in FIG. 1

FIG. 7 illustrates a display screen of information on a waiting room displayed when an area of the waiting room of a sponsor frame shown in FIG. 6 is clicked.

FIG. 8 illustrates a reception screen of a message from a salesperson.

FIG. 9 illustrates a preparation screen of a message from a client to a salesperson.

FIG. 10 illustrates a display screen of a client's salesperson list.

FIG. 11 illustrates a display screen of the profile of a salesperson.

FIG. 12 illustrates a display screen of a salesperson's client list displayed on an MR terminal of the MR support system shown in FIG. 1.

FIG. 13 illustrates a setting screen of the profile of a client.

FIG. 14 illustrates a preparation screen of a message from a salesperson to a client.

FIG. 15 illustrates a preparation screen of a link associated with messages to a client.

FIG. 16 illustrates a reception list screen of messages.

FIG. 17 illustrates a client management screen.

FIG. 18 shows a salesperson's performance evaluation screen.

FIG. 19 illustrates a performance display screen by client.

### BEST MODE FOR CARRYING OUT THE INVENTION

An MR support system according to embodiments of the present invention will be described. This MR support system is a system which both supplies contents designed for people engaged in medical services and allows the medical information personnel of pharmaceutical companies and the sales personnel of medical equipment manufacturers to conduct person-to-person communication of messages with people engaged in medical services. In the following, the medical information personnel, sales personnel and the like of medical service related enterprises will be generically called MR (Medical Representatives). Also, people engaged in medical services are sometimes called clients or users.

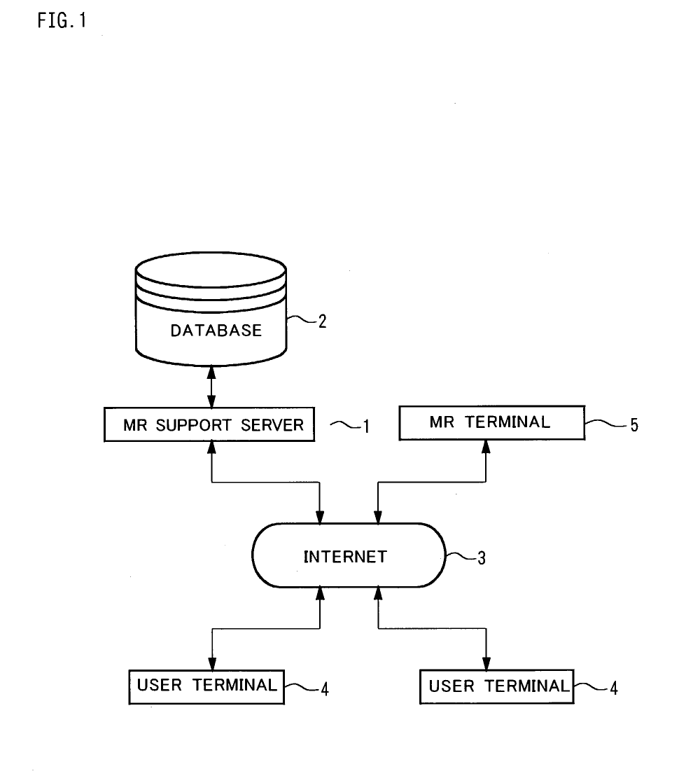

FIG. 1 shows an example of a structure of an MR support system. This MR support system includes an MR support server 1, user terminals 4 and an MR terminal 5 connected over the Internet 3. The MR support server 1, which is a server managing a contents service that can be utilized by people engaged in medical services and MRs only, is realized by an information processing apparatus, such as a personal computer or workstation, executing an MR support contents program. Connected to the MR support server 1 is a database 2 which records various information and the like.

The MR support server 1 supplies information obtained from various news media, pharmaceutical companies and so forth, as contents to the user terminal 4 in response to access from the user terminals 4 utilized by people engaged in medical services and at the same time manages the exchange of messages between people engaged in medical services and MRS. This message service is offered to people engaged in medical services and MRs as a service that has functions equivalent to those of electronic mail, but its realizing mode therefor differs from the mechanism of electronic mail as will be described later.

The user terminal 4 connected to the MR support server 1 via the Internet 3 is a terminal device operated by a person engaged in medical service, which is realized, for instance, by a personal computer running a WWW (World Wide Web) browser. The user terminal 4 can browse homepages opened by the MR support server 1 or by servers of pharmaceutical companies, medical manufacturers and so forth. The user terminal 4 can also send and receive messages to and from an MR who operates the MR terminal 5, on the homepage of the MR support server 1.

The MR terminal 5 connected to the MR support server 1 via the Internet 3 is a terminal device operated by an MR, which is realized, for instance, by a personal computer running a WWW browser. The MR terminal 5 can send and receive messages to and from people engaged in medical services who operate their user terminals 4, on the homepage managed by the MR support server 1. The MR terminal 5 can also confirm as business results the reaction of people engaged in medical services to the message sent by the MR, on the homepage managed by the MR support server 1.

It is to be noted that a plurality of user terminals 4 and a plurality of MR terminals 5 exist, and a person engaged in medical service or an MR may receive service from the MR support server 1 by each logging onto the MR support server 1 by entering his/her user name and password. For a person engaged in medical service, the MR support server 1 functions as a portal site for people engaged in medical services, providing also the function for message exchange with MRs as will be described later. For an MR, on the other hand, the MR support server 1 provides the function for message exchange with people engaged in medical services and a user interface for preparation of messages as will be described later.

An operator who operates the MR support server 1 carries on business by collecting the charge from pharmaceutical companies under a contract for the use of the MR support system or by setting banner advertisement on the homepage. It may also be so arranged that people engaged in medical services are charged for the use of the MR support system.

The operator who operates the MR support server 1 assigns to each pharmaceutical company having entered into a contract for the use of the MR support system a service code containing information that can at least identify the pharmaceutical company.

Next, a procedure leading to the use of the MR support system by a person engaged in medical service will be described. The MR support server 1 has the function as a portal site that supplies contents attuned to people engaged in medical services. As a person engaged in medical service logs on to the MR support server 1 by entering his/her user ID and password, medical information customized for the person engaged in medical service is displayed on a browser screen. Further, the person engaged in medical service may also browse medical information distributed restrictively by a registered pharmaceutical company by obtaining a service code from an MR of the pharmaceutical company under contract with the operator of the MR support server 1 and registering the service code with the MR support server 1. Displayed on the browser screen is not only information as a portal site but also a sponsor frame, described later, where a message from the MR will be shown. And with this sponsor frame as a starting point, it becomes possible that one-on-one communication with the MR is conducted.

On the other hand, an MR who wants to use the MR support system in his/her sales activity to people engaged in medical services notifies the people engaged in medical services of the service code of his/her company, thereby inviting them to use the MR support system. When informing a person engaged in medical service of the service code, the MR also informs the person of an MRID, which is an identifying data on the MR. As the person engaged in medical service registers the MRID with the MR support system in order to approve of said MR, it becomes possible that the person engaged in medical service receives messages from the MR and transmits messages to the MR. It is to be noted that the MRID is stored in the database 2 in a manner that the MRID is associated with attribute data on the MR.

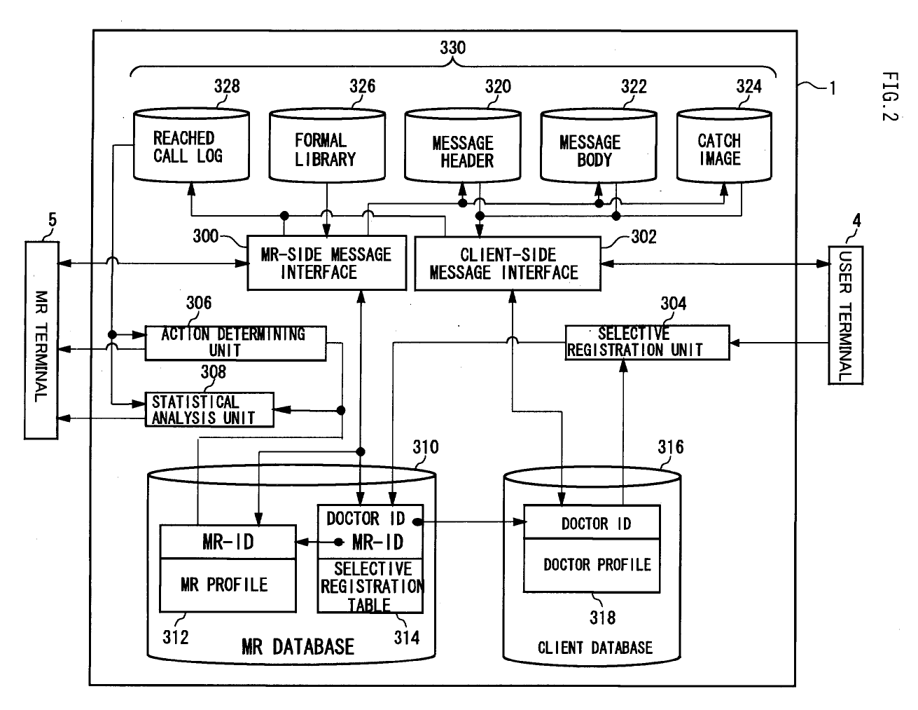

FIG. 2 shows a functional structure of an MR support server 1. This functional structure can be realized by hardware, such as the CPU of a computer and other elements, or by software, such as a program having an MR support function. Illustrated here, however, are functional blocks that can be realized by the cooperation thereof. Thus, these functional blocks can be realized in a variety of forms by the combination of hardware and software.

The MR support server 1 includes an MR-side message interface 300, a client-side message interface 302, a selective registration unit 304, an action determining unit 306, a statistical analysis unit 308, an MR database 310, a client database 316 and a message database 330. The MR database 310, the client database 316 and the message database 330 are what is represented as the database 2 in FIG. 1.

The MR database 310 contains an MR table 312 and a selective registration table 314, whereas the client database 316 contains a client table 318. The selective registration unit 304 accepts the input of MRIDs, which are identifying codes of MRs, from user terminals 4 of people engaged in medical services. The selective registration unit 304 extracts from the client database 316 the client table 318 that is identified by the user ID of a person engaged in medical service, extracts from the MR database 310 the MR table 312 that is identified by an MRID, and generates the selective registration table 314 associating the client table 318 with the MR table 314. Once this selective registration table 314 is generated, it means that the MR identified by the MRID is registered with the person engaged in medical service identified by the user ID, so that the MR can become in charge of said person engaged in medical service as his/her client. With the selective registration table 314 generated, the MR-side message interface 300 enables the MR to transmit messages to the person engaged in medical service. The selective registration table 314 functions also as a client list file that allows entry of a note on any registered person engaged in medical service, and the MR prepares messages to the registered person engaged in medical service, using this client list file.

The MR-side message interface 300 is a user interface which supports an MR so that the MR can prepare, delete, store and so forth, messages to be sent to people engaged in medical services and the MR can read, delete, store and so forth, messages received from people engaged in medical services. Header portions for messages prepared by the MR are stored in a message header database 320, and statuses, such as transmission dates and times of the messages and the dates and times at which addressee people engaged in medical services opened the messages, are managed. The body of a message is stored in a message body database 322. The MR can use a photo of his/her face or illustrated image as part of a guidance image for message by selecting it from a catch image database 324. It is also possible that the guidance image for message contains a simple self-introduction of MR, a title of the message and/or catchphrase. Also, the MR can acquire appropriate data from a formal library database 326 which stores fixed messages and fixed link addresses prepared by the MR's company for business use, so as to make them serve well in preparing a message. A reached call log database 328 stores read information in a log when messages thus prepared are read by addressee people engaged in medical services, and the log is utilized in adding points for the people engaged in medical services.

The client-side message interface 302 is a user interface which supports a person engaged in medical service so that he/she can read, delete, store and so forth, messages he/she receives from the MR and he/she can prepare, delete, store and so forth, messages he/she transmits to the MR. The client-side message interface 302 reads out from the message database 330 the message sent from the MR whom the person engaged in medical service has approved by registering him/her and supplies it to a user terminal 4 of the person engaged in medical service. As will be described later, when there is a message from the MR, there are cases where a guidance image for the message from the MR, read out from the catch image database 324, is first displayed. At a click by the person engaged in medical service on the displayed guidance image, the message linked to the image is read out from the message body database 322 and displayed. Hereinafter, a message sent from an MR to a person engaged in medical service is referred to also as “a call,” and the reading of the message by the person engaged in medical service is referred to also as “reaching.” Thus, a “reached call” refers to a message from an MR which has been opened and read by the person engaged in medical service.

When a message has been read by the person engaged in medical service, the client-side message interface 302 updates the status recorded in the header of the message to an “already read” status. Also, when the person engaged in medical service reads a message, a reached call log showing when and which message has been read will be recorded in a reached call log database 328, and points that can be exchanged for some charged service or the like will be added for the person engaged in medical service.

The message database 330 is a database which is accessed by both the salesperson and the client, and the messages exchanged between the salesperson and the client are managed by this single message database 330. This arrangement therefore differs from the mechanism in electronic mail or the like in which mail data are delivered from a sender's server to a receiver's server.

An action determining unit 306 analyzes the status of a message sent by the MR to the person engaged in medical service, decides on action to be taken for the person engaged in medical service, and presents it to the MR. The statistical analysis unit 308 analyzes the business performance of the MR based on status of contact to people engaged in medical service, such as the number of messages sent by the MR to people engaged in medical services and the ratio of the messages read by people engaged in medical services, and presents evaluation results to the MR terminal 5.

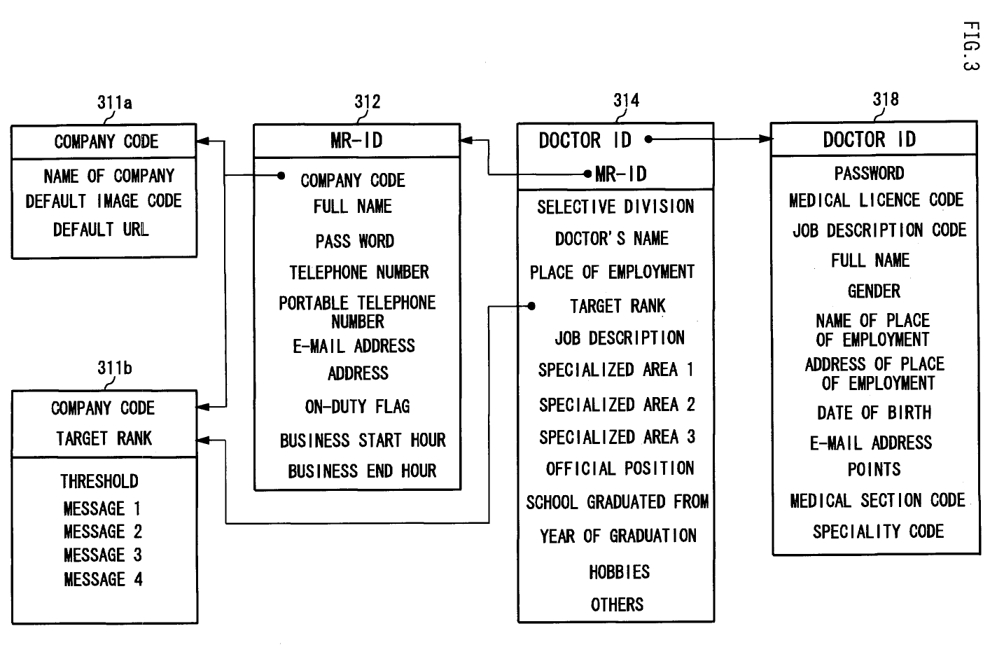

FIG. 3 shows data structures of the MR table 312, the selective registration table 314 and the client table 318, and reference relations between them. The MR table 312 includes MR's company code, full name, password with which the MR accesses the MR support server 1, MR's telephone number, portable telephone number, electronic mail address, address, on-duty flag to show whether he/she is now on duty or not, and MR's business start and end hours, which are all identified uniquely by MR's MRID. The business start and end hours are used not only to inform people engaged in medical services of the MR's business hours but also to output at the terminal of a person engaged in medical service a warning message like “Off-duty hour and no immediate response available” when he/she tries to send a message to the MR at business off-hours. An on-duty flag is used not only to inform people engaged in medical services of whether the MR is now on duty or away on vacation but also to display a warning message when he/she is away on vacation.

Part of the information stored in the MR table 312 is presented to a person engaged in medical service in such a manner that it is stored in the MR list of the person engaged in medical service as profile of the MR when the person engaged in medical service registers said MR. Electronic mail, when set for open, is offered to the person engaged in medical service, but otherwise will not be offered to the person in medical service. In this manner, not necessarily all the information in the MR table 312 is disclosed to the person engaged in medical service who has registered the MR. Also, the MR, who is often away from his/her office, may register the mail address of his/her portable telephone in the MR table 312 and make such an arrangement that the MR support server 1 transfers messages from clients to mail address of his/her portable telephone.

The client table 318, which is identified uniquely by a doctor ID, stores a password with which the doctor accesses the MR support server 1, medical license code, job description code, full name, gender, name of the place of employment, address of the place of employment, date of birth, electronic mail address, points, medical section code and specialty code. Personal information on the doctor stored in the client table 318 is not disclosed to the MR except for part of it, such as his/her full name and the name of the place of his/her employment.

The selective registration table 314 associates a doctor's client table 318 with an MR's MR table 312 only when the doctor has approved of the MR by registering him/her, and is identified uniquely by the MRID of the MR table 312 and the doctor ID of the client table 318. The selective registration table 314 has entry into which the MR can input a note regarding the doctor, such as a selective division that determines where in a sponsor frame (described later) the guidance image for messages from the MR is shown, doctor's full name, place of employment, target rank that shows importance of a client, job description, specialized area, official position, school graduated from, year of graduation, hobbies and so forth. It is to be noted, however, that the selective division can be set by the doctor only, and not by the MR. These pieces of information on the doctor, which are inputted by the MR, do not necessarily agree with personal information on the doctor stored in the client table 318. This selective registration table 314 is also used as the MR's client list file.

Company data 311a is referred to from the MR table 312 and stores the name of the company the MR belongs to, a code indicating a default image, such as a logo type of the company, and a default URL, such as homepage of the company. Action data 311b is a data file identified by the company code of the MR table 312 and the target rank of the selective registration table 314 and stores decision criteria for action to the client and the contents of action. Thresholds to be used in the decision criteria for action and four kinds of messages describing the contents of action are stored. Usage of the action data 311b will be described later.

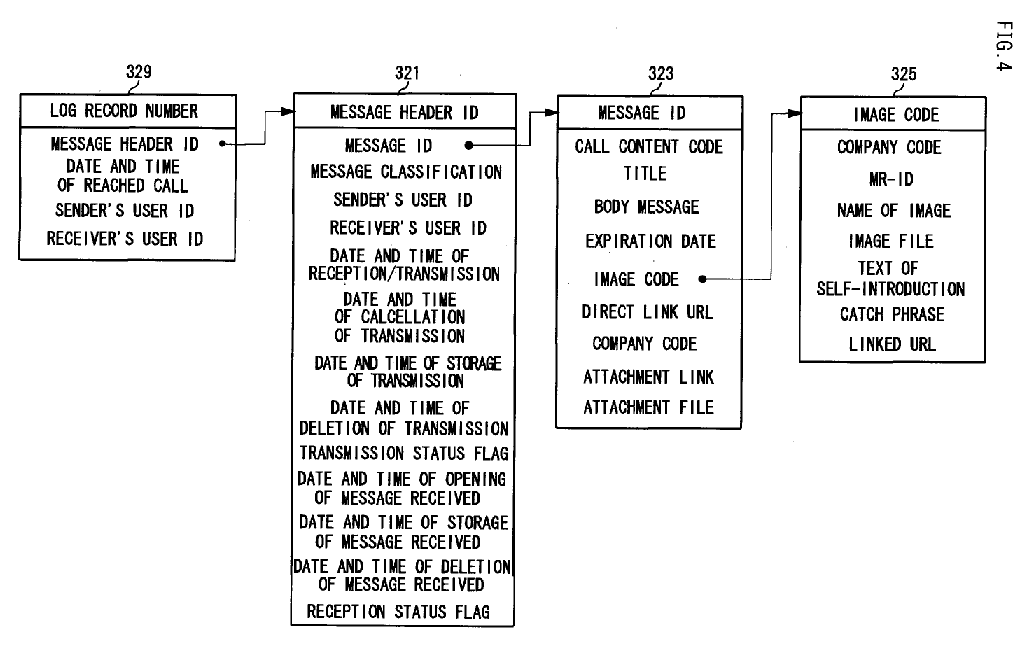

FIG. 4 illustrates data structures of a message header record 321, a message body record 323, a catch image record 325 and a reached call log record 329, and reference relations between them. The message header record 321 stored in the message header database 320, which is identified uniquely by a message header ID, stores a message ID, message classification, sender's user ID, receiver's user ID, date and time of reception/transmission, date and time of message cancellation by a sender side, date and time of storage, transmission status flag, date and time of deletion, date and time of message opening by a receiver side, date and time of storage, date and time of deletion and reception status flag.

Here, the message ID is a pointer pointing at the record of the body of this message. The message classification indicates whether the message is a normal message addressed to the client or a system message transmitted by the MR support server 1 with the purpose of notifying the MR of it. The system message, as will be described later, includes MR registration notice, MR deletion notice and message opening notice. The sender's user ID and the receiver's user ID are either the MR's user ID or the doctor's user ID. In the case of the system message, however, the sender's user ID is a manager ID.

The message body record 323 stored in a message body database 322, which is identified uniquely by the message ID, stores a call content code, title of the message, body of the message, expiration date, image code, direct link URL, company code, attachment link and attachment file. Here, the call content code shows a classification of a message to the client, such as business, advertisement or request. The image code, which is a code of catch image, indicates the record of a catch image. The direct link URL is an URL to be linked by the choice of the MR himself/herself. The attachment link, on the other hand, is a fixed link prepared by the MR's company side, and an image file or text data, in addition to the URL, may be further attached to this fixed link. The attachment file includes a document file to be attached to the message.

The catch image record 325 stored in a catch image database 324, which is identified uniquely by the image code, stores a company code, MRID, name of the image, image file, text of MR's self-introduction, catch phrase and URL to be linked.

The reached call log record 329 stored in the reached call log database 328, which is identified uniquely by a log record number, stores a header ID of a message opened by the doctor, date and time of a reached call indicating the date and time when said message was opened, and the user IDs of the sender and the receiver of the message. Using this reached call log record 329, points to be added for the doctor are determined according to the number of times he/she has opened messages.

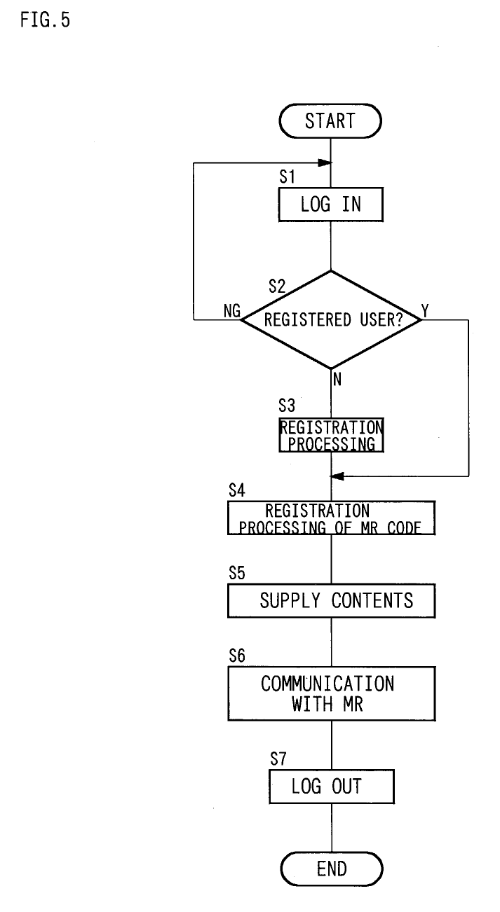

A general structure of an MR support system according to a preferred embodiment has been described, and its processing is described hereinbelow by concrete examples. The general flow of processing at the MR support server 1 will be described with reference to the flowchart shown in FIG. 5. This processing is started when the MR support server 1 has detected an access from the user terminal 4.

The MR support server 1 transmits a log-in screen, which prompts the input of an user ID and password, to the user terminal 4 via the Internet 3 (S1). Provided on the log-in screen are entry columns for a user ID and password, a send button that instructs the transmission of the entered user ID and the like, a notification button that notifies him/her of a status of being an unregistered user, and so forth. In response to the log-in screen displayed on the user terminal 4, a person engaged in medical service operating the user terminal 4 enters the user ID and password in the log-in screen and clicks on the send button if he/she is a registered user. On the contrary, if he/she is an unregistered user, the user clicks the notification button. Upon the click of either the send button or the notification button, the entered user ID and password or the unregistered user notice will be transmitted from the user terminal 4 to the MR support server 1 via the Internet 3.

The MR support server 1 receives the user ID and password or the unregistered user notice from the user terminal 4, and judges whether the user is a registered user or not based on the content of the reception (S2). To put it concretely, when the user ID and password are received, they are checked against a user profile recorded in the database 2 and whether or not they are authentic is judged. If the user ID and password are judged unauthentic (NG of S2), the processing will return to step S1 and the log-in screen will be transmitted again.

When the unregistered user notice is received (N of S2), the user is judged to be an unregistered user and the processing goes to step S3. The MR support server 1 transmits a user registration screen, which prompts the user to register, to the user terminal 4 via the Internet 3 (S3).

Provided on the user registration screen displayed on the user terminal 4 are entry columns for user ID and password where the user can set his/her arbitrary characters or numerals, entry columns for the service code obtained from the MR, full name, gender, date of birth, job description, specialized department, place of business and so forth, and a send button that instructs the transmission of the entered user ID and so forth. Here, the job description is hospital doctor, practicing doctor, nurse, pharmacist, medical technologist and so forth, whereas the specialized department is internal medicine, surgery and so on. When the send button is clicked after the user enters the user ID, password, service code and so forth in response to a user registration screen displayed on the user terminal 4, the entered user ID, password, service code and so forth will be transmitted to the MR support server 1 via the Internet 3.

By the way, the service code acquired from the MR has at least a record of information identifying the MR's pharmaceutical company, as has been described above, but the person in medical service may be notified of the service code that further includes information on his/her gender, date of birth, job description, specialized department, place of business and so forth. This will reduce the number of items that the person in medical service enters in the user registration screen, thus lessening the trouble of the person in medical service in his/her user registration.

The MR support server 1 records the user ID and so forth from the user terminal 4 by storing them in the client table 318 of the client database 316 as a user profile. Thereby, the user of the user terminal 4 becomes a registered user. The MR support server 1 also issues authentication information indicating that the user of the user terminal 4 is a registered user, to the user terminal 4 being operated by the registered user. The authentication information thus issued is stored in the user terminal 4. A cookie may be used as one example of such authentication information. The MR support server 1 further records in the client table 318 the issued authentication information in such a way as to be associated with the user profile of the user.

After user registration, the user registers the MRID of the MR with whom he/she will exchange messages in an MR appointment form for exclusive use with said user, which is managed by the MR support server 1 (S4). A plurality of MRIDs can be registered in this MR appointment form. The user can receive messages transmitted only by MRs whose MRIDs are registered in the MR appointment form. In other words, an MR cannot send messages to a user unless the user registers the MR's MRID in the MR appointment form. Therefore, the user can reject the reception of messages from unappointed MRs by not registering such MRIDs in the MR appointment form.

In this manner, a person in medical service establishes a one-on-one communication channel with an MR by approving the MR by registering his/her MRID. Also, as viewed from the MR, it becomes possible for the MR to operate a so-called permission marketing to people in medical service by having them register his/her MRID. It is to be noted that addition or deletion of contents entered at user registration and addition of MRIDs in the MR appointment form and registration cancellation therefrom can be made at any time.

If the user ID and password are received at step S2 and their authenticity is confirmed by the check against the user profile recorded in the database 2 (Y of S2), the processing of step 3 will be skipped because of the judgment on the user being a registered user.

Next, the MR support server 1 reads out the user profile from the client table 318 of the client database 316 and, based on the user profile, supplies contents attuned to the person in medical service (S5), and displays the message from the MR, thus urging the user to communicate with the MR (S6). The user logs out of the MR support server 1 (S7), completing a series of processings. It is to be noted that since this service is used on a browser, a session may be closed automatically by a timeout and not by prompting the user to log out.

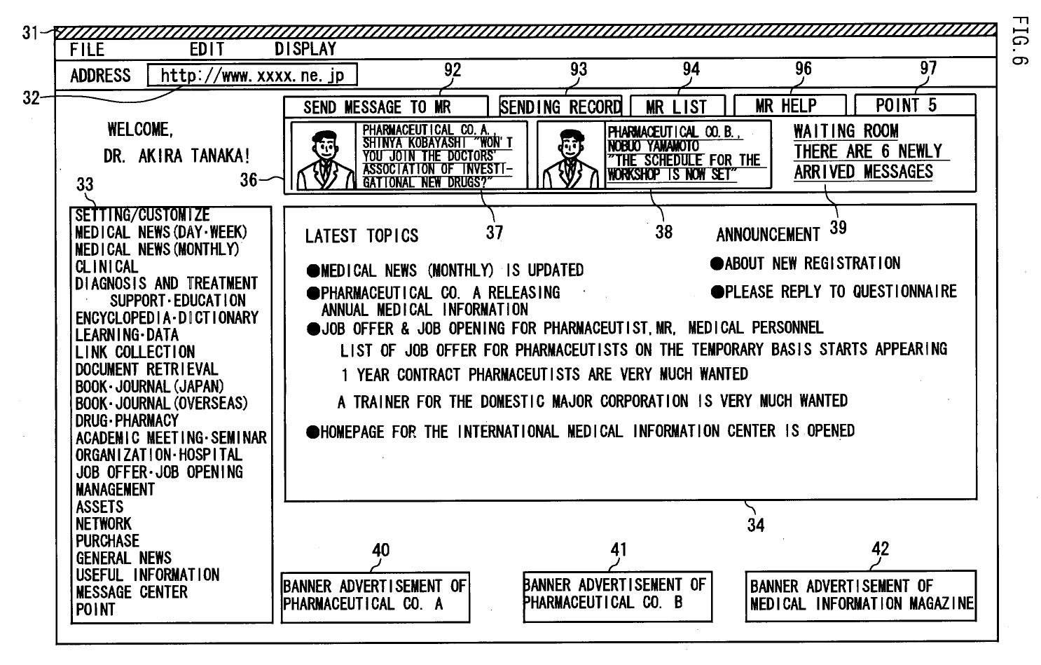

FIG. 6 shows an example of display of a WWW browser window 31 to be displayed on the user terminal 4 operated by Dr. Akira Tanaka, who is a person in medical service. To be entered in an address input column in the WWW browser window 31 is a URL (Uniform Resource Locator) of a homepage to be accessed. Here, the doctor accesses the MR support server 1 by entering the URL of the MR support server 1. Displayed in a navigation frame 33 are items of information that will be displayed in a main frame 34. At a click of an item displayed in the navigation frame 33, the headings of information on the clicked item will be displayed in the main frame 34. In the example shown in FIG. 6, the headings “Latest Topics” and “News” are displayed in the main frame 34.

The character string of the heading of information, for example, “Pharmaceutical company A releasing annual medical information” displayed in the main frame 34 is linked to corresponding information, which is the page listing “Annual Medical Information” in this example. It is to be noted that the URL of the page to be linked is not necessarily a lower directory of the MR support server 1, which is the site now under consideration, but can be another site.

As for the term “link” in this specification, it is used in the sense that a link is made, in the above example, when the corresponding “Annual Medical Information” is displayed following the click of the character string “Pharmaceutical company A releasing annual medical information.”

A sponsor frame 36 is comprised of areas 37, 38 and 39, which are each linked to the page for two-way communication, described later, in which messages are exchanged between the user and the MR. The areas 37 and 38 are each an area dedicated to a predetermined pharmaceutical company. When a message is being transmitted by the MR of the pharmaceutical company to the user, who is Dr. Akira Tanaka, a guidance image for said message is display in the area. When no message is being transmitted, the area displays a mark, logotype or the like of the pharmaceutical company instead.

In the example of FIG. 6, the area 37 is an area dedicated to pharmaceutical company A, which is displaying a message “Won't you join the Doctors' Association of Investigational New Drugs?” sent by Shinya Kobayashi, who is an MR of pharmaceutical company A. In a similar manner, the area 38 is an area dedicated to pharmaceutical company B, which is displaying a message “The schedule for the workshop is now set.” sent by Nobuo Yamamoto, who is an MR of pharmaceutical company B. The areas 37 and 38 are each linked to information set by the corresponding MR, for example, detailed information or the like concerning the message, and are structured such that detailed information is displayed at the click by the doctor.

The area 39 displays: “Waiting Room: There are N newly arrived messages.” The area 39 is linked to the Waiting Room page where the user can read through the messages sent from MRs whose MRIDs the user has registered in the MR appointment form. In the Waiting Room page, messages from all registered MRs including MRs other than those displayed in the areas 37 and 38 will be displayed. As a display in the area 39 guided to the Waiting Room, the number of MRs standing by at the Waiting Room, instead of the number of newly arrived messages, may be displayed. The user can arbitrarily set pharmaceutical companies that can use the areas 37 and 38 exclusively, selected from among the pharmaceutical companies to which the MRs whose MRIDs have been registered in the MR appointment form belong.

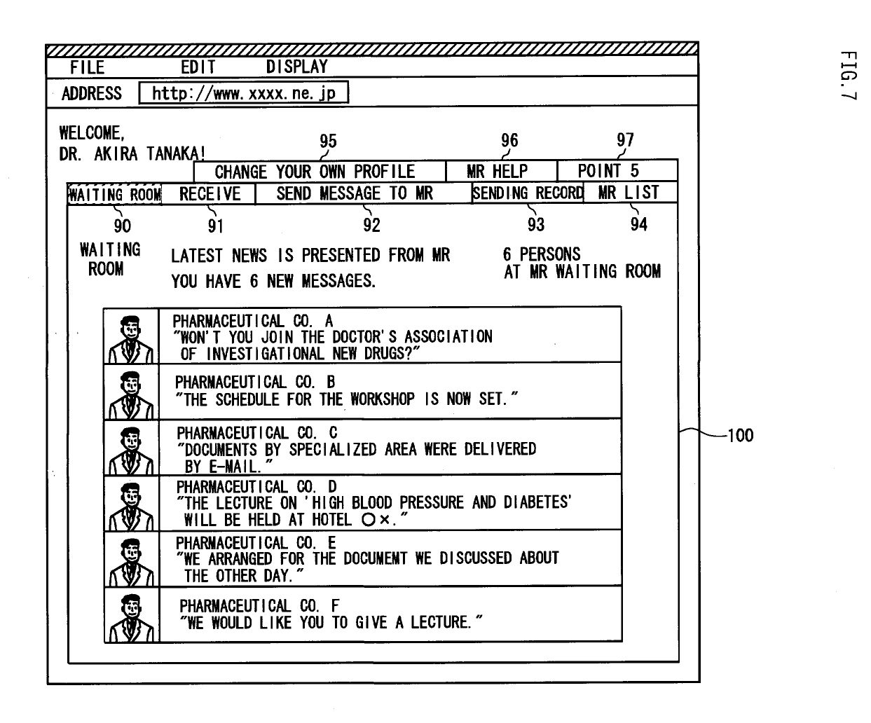

Provided in the upper part of the sponsor frame 36 are various tags 92, 93, 94, 96 and 97. These tags are the same as those displayed on the screen for communication with the MR to be described with reference to FIGS. 7 to 11, and therefore their description will be given with each of the figures.

In response to the screen displayed at the user terminal 4, if the user instructs a change in the information to be displayed by clicking the item of information displayed in the navigation frame 33, clicking the heading displayed in the main frame 34, clicking the area 37 or 38 of the sponsor frame 36, or clicking banner advertisements 40 to 42, or entering a URL in the address input column 32, then a URL linked to the clicked point or the URL entered in the address input column 32 will be transmitted from the user terminal 4 to the MR support server 1 via the Internet 3. As a result thereof, contents to be displayed on the browser is newly transmitted to the user terminal 4, thus switching the display contents. Examples of display of contents thus transmitted to the user terminal 4 are shown in FIGS. 7 to 11.

FIG. 7 shows an example of display of information on the Waiting Room to be displayed when the area 39 of the Waiting Room of the sponsor frame 36 is clicked. Various tags 90 to 97 are provided in the upper part of a main frame 100, and, in this example, a Waiting Room tag 90 is selected and the information in the Waiting Room is displayed in the main frame 100. In the main frame 100, messages transmitted to the user by the MRs whose MRIDs are registered in the MR appointment form are displayed. The character string of a message from each MR displayed in the main frame 100 is linked to information related to said message set by each MR, in a similar manner as in the areas 37 and 38.

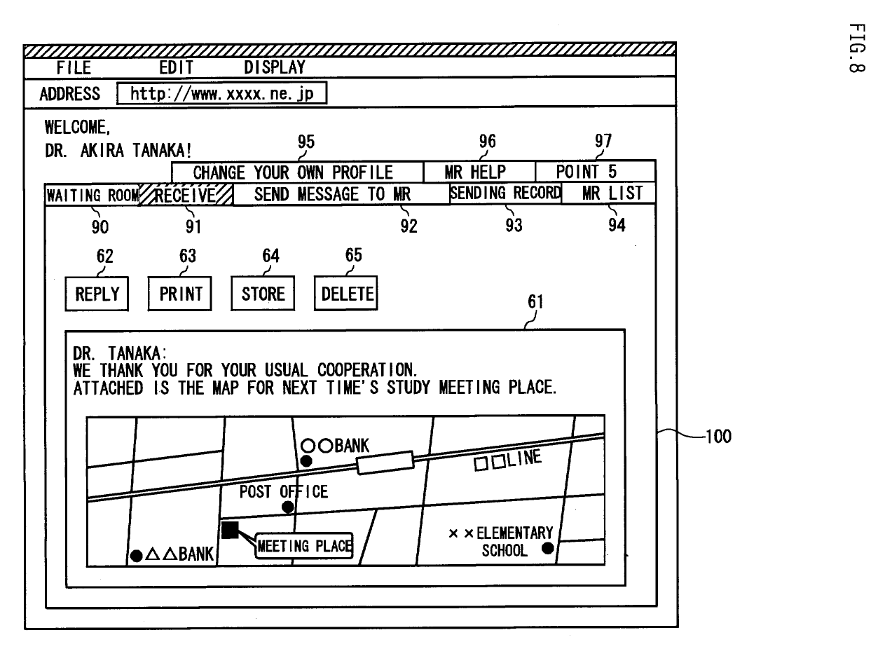

For example, when a message from the MR of pharmaceutical company B displayed in the area 38 of the sponsor frame 36 in FIG. 6 or in the main frame 100 in FIG. 7 is clicked, information in a linked site set by the MR of pharmaceutical company B, or in this case an image 61 of text data of a message body and a map, is displayed in the main frame 100, as shown in FIG. 8. In response to the display of information in the linked site, the display in the area 38 in FIG. 6, which has belonged exclusively to pharmaceutical company B, is switched to the mark and logotype of the same company. To this message, the user can perform a processing of replying, printing, storing or deleting by clicking a reply button 62, a print button 63, a store button 64 or a delete button 65.

Moreover, when the user clicks the character string of a message displayed in the area 37 or 38 or in the main frame 100 in order to display information related to the message from the MR, the date and time of clicking the relevant message is recorded in the reached call log database 328 and the date and time of opening and status flag are updated and recorded in the applicable header of the message header database 320, at the MR support server 1.

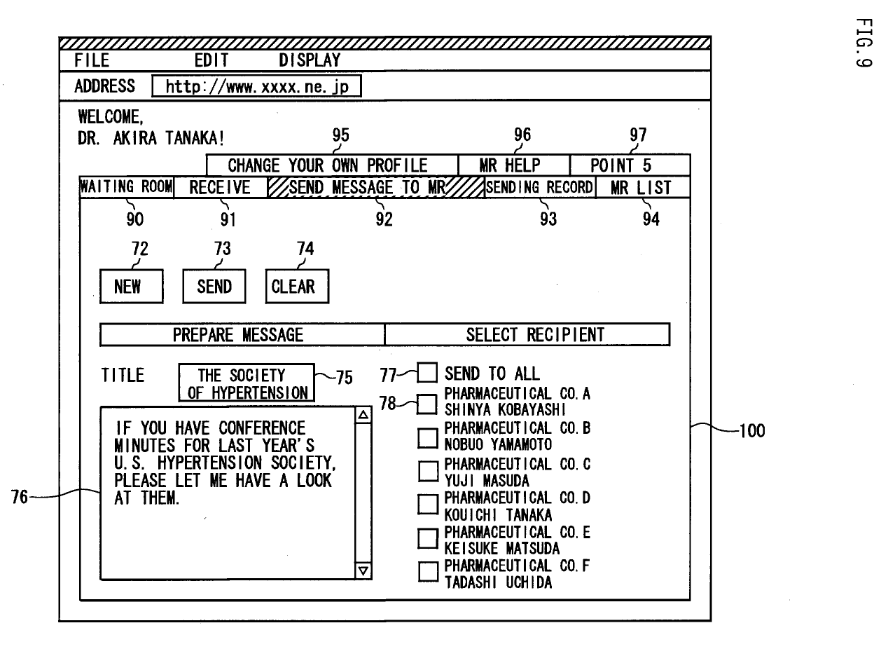

FIG. 9 shows a message preparation screen to be displayed in the main frame 100 by a click of the “Send Message to MR” tag 92. A New button 72 in the main frame 34 is clicked when a new message is prepared. A Send button 73 is clicked when a message inputted in a message input column 76 is to be transmitted to a receiver or receivers selected by a check box 77 or 78. A Clear button 74 is clicked when the message input column 76 or the check in the check box 77 or 78 is to be cleared. In a title input column 75, the title of the message to be transmitted is inputted. In the message input column 76, a message to be transmitted is inputted. The check box 77 is checked when all MRs whose MRIDs are registered in the MR appointment form are to be selected as receivers of the transmission. The check box 78, which is provided for each MR, is checked when the corresponding MR is to be selected as a receiver of the transmission.

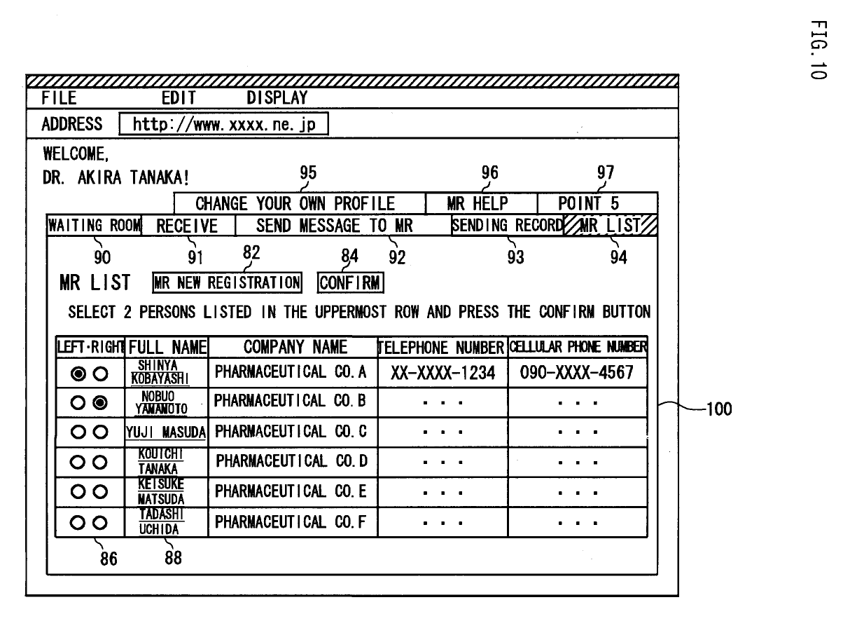

FIG. 10 shows an example of display in the main frame 100 to be displayed when an “MR List” tag 94 is clicked. A list of MRs who have been registered by the user is displayed, and the MRs to be displayed in the left and right areas 37 and 38 in the sponsor frame 36 can be selected by operating a selective section check button 86. The MR for whom the left of the selective section button 86 was selected is displayed in the left area 37 of the sponsor frame 36, whereas the message of the MR for whom the right of the selective section button 86 was selected is displayed in the right area 38 of the sponsor frame 36. Although MRs for whom the selective section check button 86 has not been selected are not displayed in the sponsor frame 36, message from the MR can be read in the Waiting Room. The set content is updated by clicking a Confirm button 84 after selecting the selective section check button 86. At a click of an MR New Registration button 82, the display changes to a screen for registration of a new MR, thus prompting the user to enter an MRID. At the registration of the MRID, the MR is newly registered and added to the MR list. The name of the MR is hyperlinked, so that clicking the name will switch the display to a screen for displaying a profile of the MR.

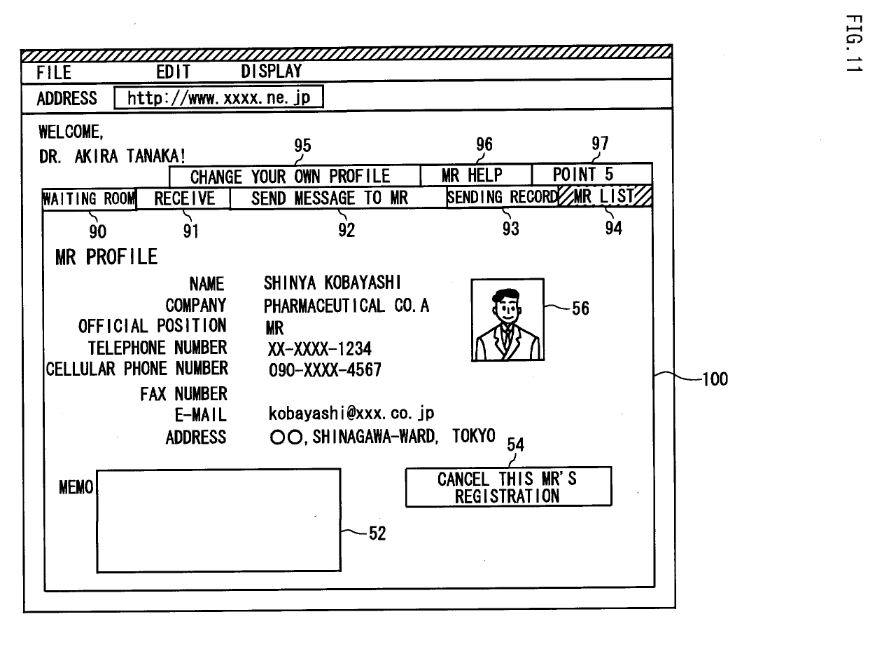

FIG. 11 shows an example of display of the profile of the MR to be displayed when the name of the MR is clicked on the screen of FIG. 10. In this example, the profile of the MR of pharmaceutical company A, including his/her telephone number, public electronic mail, address and so forth, is being displayed together with the MR's photograph 56. In a memorandum column 52, the doctor can enter notes or the like on the MR. At a click of the “Cancel This MR's Registration” button 54, the registration of this MR will be nullified and deleted from the MR list. With the nullification of the registration, the doctor will no longer be able to send messages to this MR nor receive messages from this MR.

Though not illustrated, the user can change his/her own profile by clicking a “Change Your Own Profile” tag 95. Since the MR support server 1 as a portal site changes information to be presented to the user according to the personal attributes set in the profile, it is desirable that the user change the profile as appropriate whenever there is any change in his/her interests or specialized field.

At a click of a “Sending Record” tag 93, the display switches to a screen showing a list of messages transmitted by the user to MRs. At a click of an “MR Help” tag 96, a manual on the use of tools for communication with MR will be displayed. A “Point” tag 97 is displaying 5 points at the tag, which are the points so far obtained by the user, and a click of this tag will switch the display to a screen for confirmation or possible use of the points.

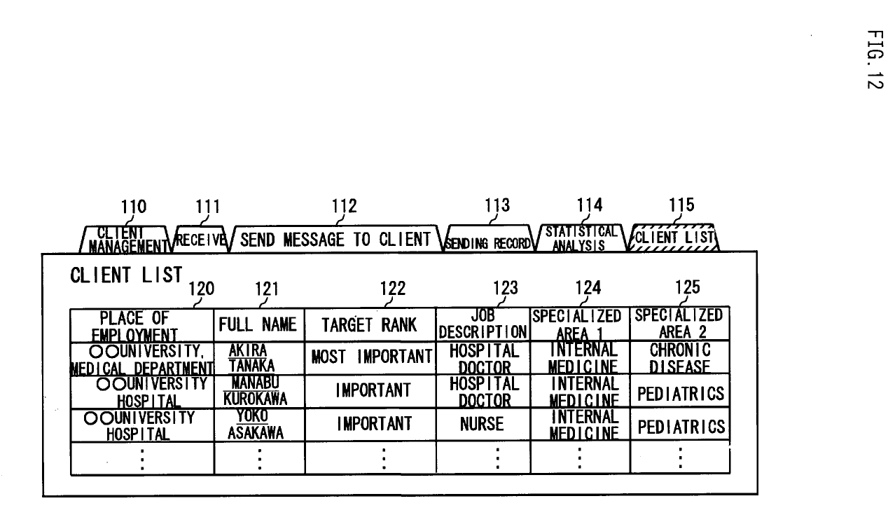

Next, FIGS. 12 to 19 will be used to specifically explain processings in which the MR terminal 5 accesses the MR support server 1 and exchanges messages with people in medical services. Shown in FIGS. 12 to 19 are screens displayed after a log-in screen is reached with the MR terminal 5 entering the URL of the MR support server 1 using a browser and after the entry of the user name and password. For the simplicity of explanation, the window of the browser is omitted, and the main frame 102 displayed within the window and various tags 110 to 115 provided in the upper part of the main frame 102 are shown.

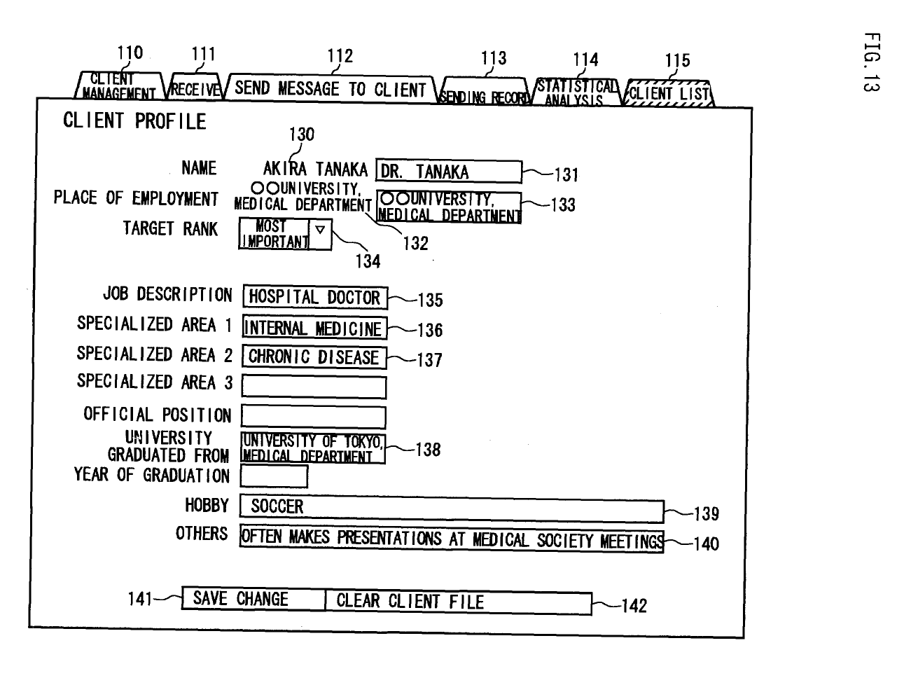

FIG. 12 shows a client list to be displayed at a click of a “Client List” tag 115. Places of employment 120 and full names 121 of persons in medical services who are under the MR's charge are displayed in a list. These pieces of information are presented to the client list of the MR when the person in medical service registers the MRID of the MR. Displayed in sections other than these, namely, in a target rank 122, job description 123, primary specialized area 124 and secondary specialized area 125 is information which the MR has entered as notes. The names of the persons in medical service are hyperlinked, so that when clicked, the display will switch to a screen for setting a profile of the person in medical service as shown in FIG. 13. On this screen, the MR can input the profile of the client as his/her own note. As for the full name and place of employment, their names as have been given at the time of registration can be changed by entering new ones in a full name input field 131 and a place of employment input field 132. In a target rank selection field 134, the MR selects one at his/her option from “Most Important,” “Important” and “Regular.” Similarly, a job description input field 135, primary specialization input field 136, secondary specialization input field 137, alma mater input field 138, hobby input field 139 and other information input field 140 are provided for free entry by the MR of whatever he/she wants to remember about the doctor. For example, in the secondary specialization input field 137, the MR can enter as a memorandum the fact that the doctor is an expert on chronic disease and provide carefully thought out service to him/her by offering the latest information on chronic disease and so on. In the other information input field 140, the MR takes notes of doctor's interest in academic meetings, like, for example, “Often makes presentations at medical society meetings” and actively offers information on related academic meetings, thus arousing the doctor's interest and contributing to business activity. The MR checks contents thus inputted and save the inputted contents by clicking a “Save Change” button 141. Also, the MR can erase all the information inputted about this doctor by clicking a “Clear Client Profile” button 142.

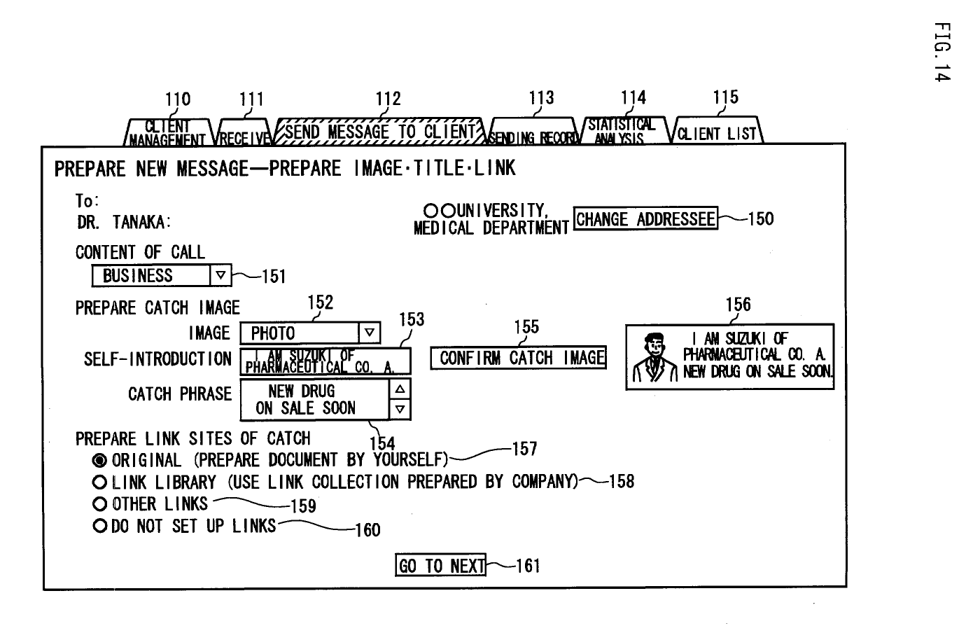

FIG. 14 shows a message preparation screen to be displayed at a click of the “Send Message to Client” tag 112. The MR selects a person in medical service registered in the client list and prepares a new message. Shown here is a message preparation screen when the MR has selected Dr. Tanaka. It is possible that the addressee is changed to another person in medical service registered in the client list by clicking a “Change Addressee” button 150. It is also possible to select a plurality of persons in medical services as addressees and prepare a multiple-address message to them. In a call content selection field 151, the MR can select the category of call content from such types as business, request for a seminar, invitation to a lecture class, introduction of new drugs and the like. The MR can prepare an image called a catch image, which gives a guidance to the message. Selecting a photo, illustration image, logo or the like in an image selection field 152, the MR determines an image to be displayed in the catch image to be a photograph of his/her face, portrait, logo of the company or the like. Also, in a self-introduction input field 153, the MR enters a simple phrase introducing himself/herself such as “I am Suzuki of pharmaceutical company A” or the like. Also, in a catchphrase input field 154, the MR enters a catch phrase, such as “A new drug on sale soon” or the title of a message. At a click of a “Confirm Catch Image” button 155, a catch image 156 is prepared according to the input items of these catch images. As was shown in FIG. 6, this catch image 156 is displayed in the sponsor frame 36 of the addressee person in medical service.

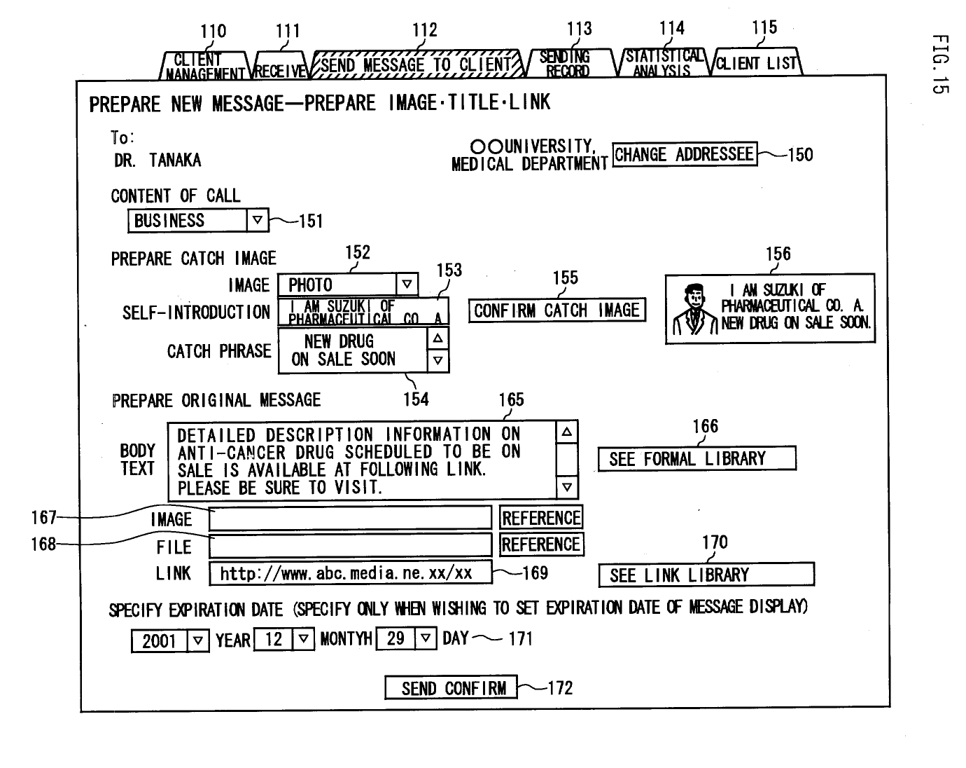

Next, the MR prepares links to be associated with this catch image 156. Specifying as the link site any one of an original message prepared by MR 157, a link library prepared by MR's company 158, other URL links specified by MR 159 and no link 160 and then clicking a “Go to Next” button 161 will switch the display to a link preparation screen. Now suppose that the original message prepared by MR 157 was selected. FIG. 15 shows the link preparation screen which is displayed then. A body text of the message is freely entered in an original message input field 165. By clicking a “See Formal Library” button 166, a model sentence for use with business prepared by the MR's company or a model form such as an invitation for a lecture meeting can be selected and pasted to the body text.

An image specification field 167 specifies a directory where an image file to be displayed attached to the message is stored or a URL indicating the position on the Internet where the image file is stored. Where the image file thus specified is one stored in the MR terminal 5, its copy will be stored in the database of the MR support server 1 and it will be displayed attached to the message to the person in medical service. Also, where the position of the image file is specified by the URL, data will be read out from the position on the Internet specified by the URL and displayed when the message is opened. One example of the image file is map data to be attached to the invitation for a lecture meeting. To be specified in a file specification field 168 is a file which one desires to attach to the message. One example thereof is a document file to be distributed attached to the message. This document file, too, is initially stored locally at the MR terminal 5, so that it may be copied in the MR support server 1, or it may be one prepared in advance in a formal library database 326 of the MR support server 1. The URL of the link site is inputted in a link site input field 169. By clicking a “See Link Library” button 170, the URL of the link library for use with business prepared by the MR's company, such as a new drug advertisement page or a page for invitation to a lecture meeting, can be selected and pasted to the link site input field 169. The link sites thus specified will be displayed at the terminals of addressee persons in medical services together with the body text of the message.

In a case where expiration date of a prepared message is to be set, the expiration date is inputted in a time limit specification field 171. The expiration date is set when the content of a message has a time limit as in the case of an invitation to a lecture class. With messages past the time limit, the image guiding the message will not be displayed at the user terminal 4. When the preparation of a message is completed, the user can confirm the content of the prepared message and transmit the message by clicking the “Send Confirm” button 172.

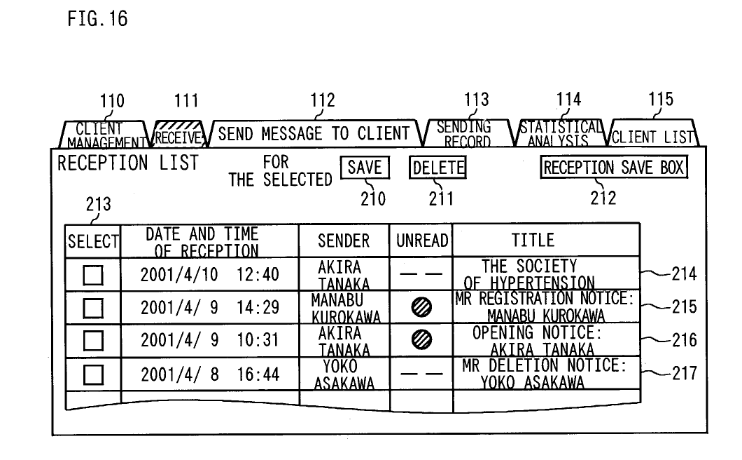

FIG. 16 shows a reception list screen to be displayed at a click of a “Receive” tag 111. Messages received from persons in medical services who are under the MR's charge are being displayed in a list. A first message 214 is a message from Dr. Tanaka addressed to the MR. The message was received at the date and time shown and it is indicated in an Unread column that MR has already read this message. A second message 215 is an MR registration notice which the MR support server 1 has sent to the MR, and is a message sent for the purpose of notifying the MR that Dr. Kurokawa has registered said MR. This message is in the state of being unread. A third message 216 is an opening notice which the MR support server 1 has sent to the MR in order to notify that Dr. Tanaka has opened the message from the MR. A fourth message 217 is an MR deletion notice which the MR support server 1 has sent to notify that Nurse Asakawa has canceled the registration of the MR. The text and attached file of these messages can be read by clicking a Title area. Also, by checking a check button of a selection field 213 and then clicking either a Save 210 button or a Delete 211 button, a selected message can be saved in a reception save box provided in the database 2 of the MR support server 1 or can be deleted from the reception save box. Also, at a click of a “Reception Save Box” button 212, a list of messages stored in the reception save box will be displayed, so that the messages in the reception save box can be read.

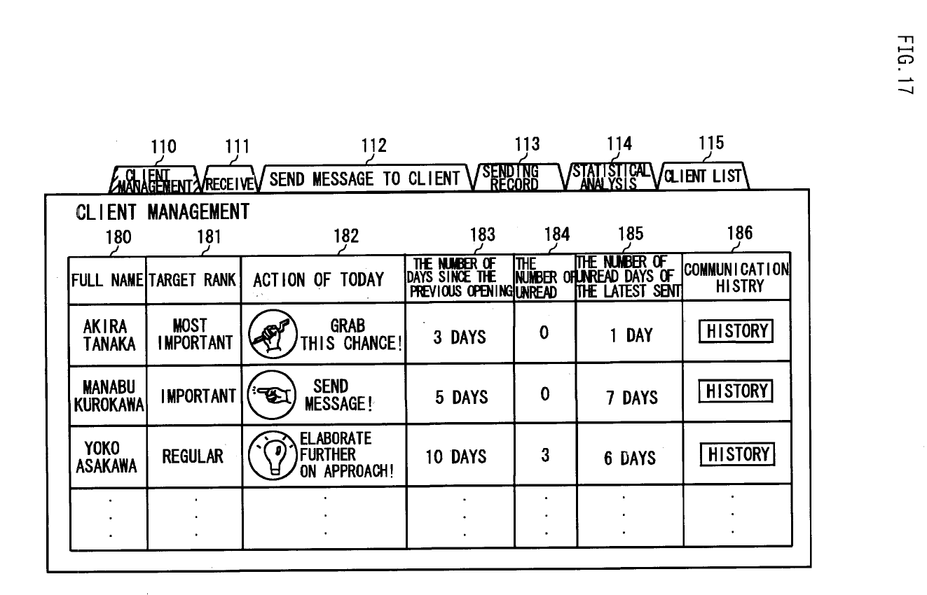

FIG. 17 shows a client management screen to be displayed at a click of a “Client Management” tab 110. Persons in medical services who are registered in the client list are displayed in a list, showing respective target ranks 181 of the persons in medical services and actions 182 to be taken in response to statuses 183, 184 and 185 of the messages sent to said persons in medical services.

One example of judgment criteria for action will be explained. When the number of days elapsed since the last opening of a message by a client is less than N and there are “0” cases of unread messages sent to the client, the approach to the client is considered a great success, and a message like “Grab this chance” is displayed. When the number of days elapsed since the last opening of a message by a client is less than N and there are 1 or more cases of unread messages sent to the client, the approach to the client is considered satisfactory, and a message like “Good” is displayed. When the number of days elapsed since the last opening of a message by a client is N or more and there are “0” cases of unread messages sent to the client, there has been no approach to the client lately and, therefore, a message like “Send message” is displayed. When the number of days elapsed since the last opening of a message by a client is N or more and there are 1 or more cases of unread messages sent to the client, there has been little response from the client and, therefore, a message like “Elaborate further on approach” is displayed.

Through differentiating the threshold N in the judgment criteria or the contents of messages between MRs' companies, it is possible to offer client management methods customized to each company. Also, the judgment criteria may be differentiated for different target ranks of the clients. For example, the threshold N may be made smaller for the most important clients, whereas it may be set larger for regular clients. Also, in addition to the above, various other condition settings are possible as judgment criteria.

The case of Dr. Tanaka in the example shown in the same figure is as follows: The target rank is “most important,” the number of days elapsed since the opening of the previous message is 3 days, there are “0” cases of messages being in the unread state, and the number of being unread of the latest message sent is 1 day. In this case, the status of contact with the client is very satisfactory, and an action such as “Grab this chance” is suggested. In the light of this suggested action, the MR conducts a positive business action toward Dr. Tanaka, thinking that this is a good chance to approach Dr. Tanaka. The case of Dr. Kurokawa, on the other hand, is: The target rank is “important,” the number of days elapsed since the opening of the previous message is 5 days, there are “0” cases of messages being in the unread state, and the number of days of being unread of the latest message sent is 7 days. In this case, the number of days elapsed since the opening of the previous message is large and the latest message has not been read, so that an action such as “Send message” is suggested. Thereby, the MR can send a more effective message to Dr. Kurokawa and see the doctor's response. Also, in the case of Nurse Asakawa, the target rank is “regular,” the number of days elapsed since the opening of the previous message is 10 days, there are three cases of messages being in the unread state, and the number of days of being unread of the latest message sent is 6 days. In this case, there are many unread cases and even the latest message has not been read for some time, so that an action such as “Elaborate further on approach” is suggested. From this, the MR can learn that some different approach to this client is necessary, such as meeting this client directly and recommending her to purchase new products or attend some lecture class.

With any of the clients, the list of messages sent so far and the already-read status of the respective messages can be checked by pressing a “History” button of a communication history 186.

Though not illustrated, at a click of the “Sending Record” tag 113, a list of messages addressed to all the persons in medical services who are under the MR's charge will be displayed, and the statuses of whether the respective messages have been read by the persons in medical services or not can be confirmed.

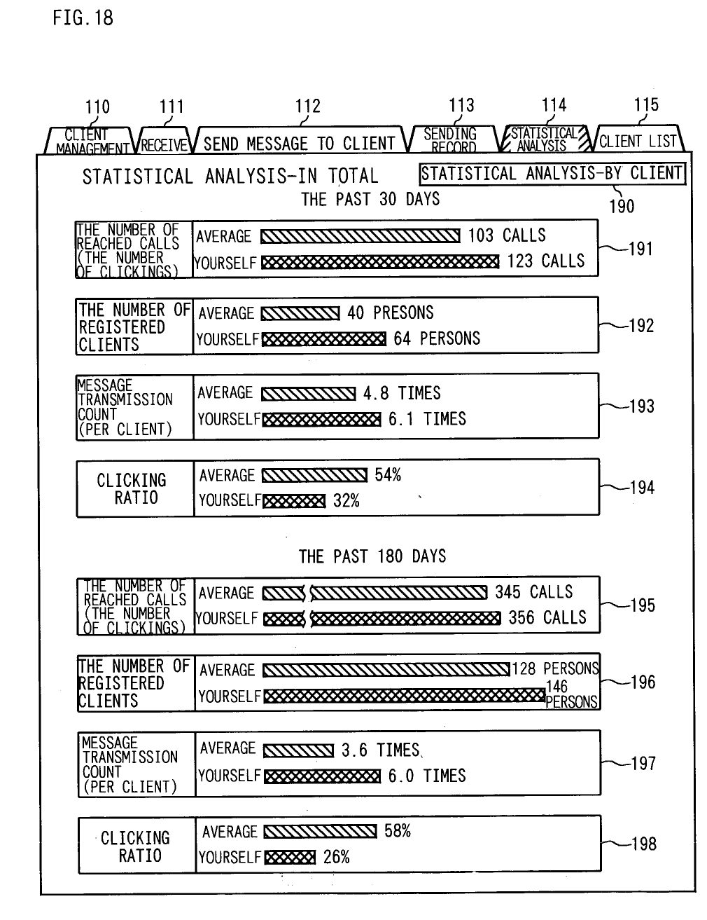

FIG. 18 shows an MR's performance evaluation screen to be displayed at a click of a “Statistical Analysis” tag 114. Based on the number of registered persons in medical services and the status of messages sent to them in the past 30 days, MR's performance is displayed in comparison with the average performance of MRs of his/her company. The number of reached calls 191 indicates the count of clickings on the messages sent to the persons in medical services. The number of registered clients 192 indicates the number of persons in medical services who has registered the MR. A message transmission count 193 indicates the count of messages transmitted per person in medical service. A clicking ratio 194 indicates the ratio of the count of clickings relative to the count of messages transmitted. This ratio can rise above 100% because there are cases where the same message is clicked a plural number of times. Shown in the lower column are results of similar evaluation in the past 180 days. In this manner, the MR can compare his/her own performance with the average of the company as a whole. Also, at a click of a “Statistical Analysis—by Client” button 190 on this screen, the display will switch to a screen that displays the MR's performance with each client under his/her charge.

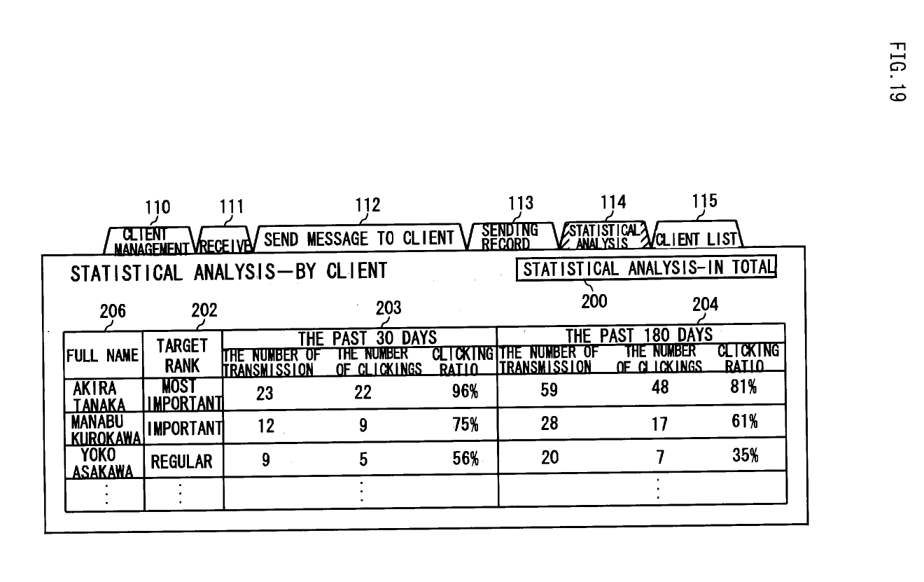

FIG. 19 shows a performance display screen by client. The clients under the MR's charge are listed up, and a performance result 203 of contact with each of the clients in the past 30 days and a performance result 204 of contact in the past 180 days are displayed together with a target rank 202. Displayed for each of the performance results are the number of messages sent, the number of clickings, and the clicking ratio. The MR can evaluate the result of his/her approach to each of the clients and make an improvement on approach to the client.

Also, with the MR terminal 5 which is operated by a person, such as an MR's superior, supervising a plurality of MRs at a pharmaceutical company, it can be so arranged that the performance of each MR is displayed individually or the performance of a plurality of MRs under his/her supervision is displayed in a list. This will enable the MR's company to evaluate the individual performance of its MRs objectively.

As has been described, the MR support system according to the present embodiments supports the so-called permission marketing, with the client approving the salesperson by registering the identifying data on the salesperson in advance and allowing the salesperson approved by the client to send messages to the client. The person in medical service selects and approves MRs to/from whom he/she sends and receives messages by registering MRIDs identifying MRs or canceling the registration thereof. It becomes possible to accept messages from MRs who have been approved and refuse the reception of direct mail or other messages from MRs who have not been approved. On the other hand, the MR of a pharmaceutical company can conduct one-on-one message exchanges with a person in medical service by having the person in medical service register his/her MRID. Also, if the person in medical service registers himself/herself with the MR support server 1 by using the service code notified by the MR, information provided by the pharmaceutical company which the MR belongs to can be shown to the person in medical service in preference to information from the other pharmaceutical companies, thus making it possible to help business activities. Also, the MR can send advertisement and guidance simultaneously to a plurality of persons in medical services by preparing a message and catch image only once. Furthermore, the MR can change the approach to the clients under his/her charge by differentiating the importance of the clients.

Furthermore, the MR can confirm, as his/her own performance, the response of the persons in medical services to the messages sent to them, such as the number of clickings or clicking ratio. A manager managing a plurality of MRs can compare and evaluate the performance of the plurality of MRs. In the past, when the MRs conducted face-to-face approach to the clients, the company could not accurately grasp the success or failure of the MRs' approach to the clients. But, according to the MR support server 1, an evaluation of the response of the clients to the messages sent by the MRs can be performed in a statistical manner, thus making it possible to objectively evaluate the service performance of the MRs.

For the operator of the MR support server 1, it is, in effect, the MRs that expand the number of users of the MR support system, because the MRs make positive efforts to encourage people in medical services to access the MR support server 1 by distributing the service codes to them based on the notion that the information from the pharmaceutical company corresponding to the service code inputted at the time of user registration is displayed preferentially.

Moreover, in the MR support system, a function as portal sites of pharmaceutical companies offering medical information to people in medical services and a function as communication of MRs of pharmaceutical companies approaching the clients by using messages are structured in an integrated manner, so that the messages from the MRs are constantly displayed in banner images in case the people in medical services gather medical information. For this reason, people in medical services can receive advertisement and other invitational messages more naturally without being bothered by direct mail and other junk mail.

In the above-described MR support system, the function as portal sites and the function as communication with the MRs are realized on the same MR support server 1, but it may be so structured that a server to realize the portal site function and a server to realize the communication function with the MRs are provided separately and thus the two functions are processed at these servers in a distributed processing. In that case, a person in medical service inputs a user ID and password when logging onto the portal site and the server realizing the portal site authenticates the user, though, it may be so structured that information concerning the user authentication is notified to the server realizing the communication function with the MRs. Or, it may be so structured that the information concerning the user authentication is shared by both the servers. By so doing, the user can also receive the service for communication with the MR simply by logging onto the portal site, and inputting his/her user ID and password only once will do the job. Even in a structure realized by separate servers in this manner, a seamless environment is realized for the user because the portal site function and the communication function with the MR are provided integrally on the user terminal 4.

In the present embodiments, the MR support system has been described as one for business activities in the medical industry, but its applications are not limited to this. The system can be applied to sales activities in all sorts of industries, including solicitation of insurance or sales of cars. This system can be preferably applied to sales promotion of goods which are purchased repeatedly and whose sales have conventionally been carried out by salespeople in face-to-face contact with customers. For example, salespersons who plan sales of merchandise, systems, services or the like to purchasing staffs of enterprises can also utilize this system. Also, when selling merchandise or services to general consumers, this system can be utilized in substitution for the conventional mail-order or electronic shopping mall sales, and it is also possible to combine the electronic shopping mall with the mechanism of permission marketing between the salesperson and the consumer just as in the present system. This way, in the goods and services where the human sales channel is an important factor, the purchasing are brisk and the sales competition is intense, the mechanism of one-on-one communication between the consumer and the salesperson based on permission as in the present system will work effectively, thus making the advertisement, promotion and sales activities of an enterprise more effective.

Moreover, although explained in the above description was a case where the MR meets a person in medical service, conveys his/her own MRID by presenting his/her name card or the like and has the person in medical service register the MR, the process of a salesperson contacting face-to-face with a client is generally not an absolute necessity. When a client selects a certain category, stock exchange for instance, at a portal site, a list of salespersons of various stock companies may be displayed or a certain number of salespersons may be recommended, so that the client selects and registers a salesperson from among them.

Industrial Usability

As has been described, the present invention can be utilized for the marketing supporting method, apparatus and system using electronic messages.

What is claimed is:

1. A marketing supporting method characterized in that it includes:
receiving an input of personal data of a client so as to be stored in a client table;
receiving an input of personal data of a salesperson so as to be stored in a salesperson table;
receiving identifying data of a salesperson in order for the client to approve the salesperson;
generating a selective registration table which, based on the identifying data that a client has inputted, associates the client table of said client with the salesperson table of an approved salesperson; and
registering entry of the client into a client list file of the approved salesperson, on the occasion of said generating the selective registration table, so as to enable preparation of a message to said client.

2. A marketing supporting method as recited in claim 1, characterized in that it further includes registering into a salesperson list file of the client an entry of a salesperson whom the customer approved of, on the occasion of said generating of the selective registration table, so as to enable preparation of a message from the client to the salesperson.

3. A marketing supporting method as recited in claim 1 or claim 2, characterized in that it further includes:
receiving the client's canceling registration of the salesperson;
notifying the salesperson whose registration was canceled, to the effect that registration has been canceled by the client;
disabling the selective registration table that associated the salesperson table of the salesperson whose registration was canceled, with the salesperson table of the client who carried out the cancellation; and
deleting an entry of the client who carried out the cancellation, from the client list file of the salesperson whose registration was canceled, on the occasion of said disabling the selective registration table.

4. A marketing supporting method as recited in any one of claim 1 to claim 3, wherein said registering entry of the client is such that in the selective registration table there is provided an entry into which the salesperson in charge of the client can input a note regarding the client, and the table is supplied as the client list file of the salesperson.

5. A marketing supporting method as recited in claim 4, wherein, as an entry for the note, there is provided an entry which sets importance of the client.

6. A marketing supporting method as recited in claim 2, wherein said registering entry of the salesperson is such that a salesperson's profile stored in the salesperson table of a salesperson whom a client approved is included in the entry of the salesperson so as to be registered into the salesperson list file of the client.

7. A marketing supporting method characterized in that it includes:
receiving an input of personal data of a client so as to be stored in a client table;
receiving an input of personal data of a salesperson so as to be stored in a salesperson table;
receiving identifying data of a salesperson in order for the client to approve the salesperson;
generating a selective registration table which, based on the identifying data that a client has inputted, associates the client table of said client with the salesperson table of an approved salesperson;
registering entry of the client into a client list file of the approved salesperson, on the occasion of said generating the selective registration table, so as to enable preparation of a message to said client; and
supporting to compose a message to be sent to a client registered in the customer list file by providing the salesperson with a formal library, prepared in advance, for use with business.

8. A marketing supporting method as recited in claim 7, wherein said supporting is such that, in order to display an image for guiding the message on a client terminal, there is provided an interface which prepares the guidance image, and an input of a catch phrase which appears in the image is received.

9. A marketing supporting method as recited in claim 7, wherein said supporting is such that, in order to display an image for guiding the message on a client terminal, there is provided an interface which prepares the guidance image, and setting of a personal image of the salesperson which appears in the image is received.

10. A marketing supporting method as recited in any one of claim 7 to claim 9, wherein said supporting further includes receiving setting of expiration date of the message from the salesperson, and disabling a message whose expiration date has passed in order for the message not to be displayed on a client-side terminal.

11. A marketing supporting method characterized in that it includes:
receiving an input of personal data of a client so as to be stored in a client table;
receiving an input of personal data of a salesperson so as to be stored in a salesperson table;
receiving identifying data of a salesperson in order for the client to approve the salesperson;
generating a selective registration table which, based on the identifying data that a client has inputted, associates the client table of said client with the salesperson table of an approved salesperson;
registering entry of the client into a client list file of the approved salesperson, on the occasion of said generating the selective registration table, so as to enable preparation of a message to said client; and
displaying an image that guides a message from a salesperson whom the client approved of, on a screen of a terminal of the client.

12. A marketing supporting method as recited in claim 11, wherein said displaying is such that, upon receipt of setting of priority for a plurality of salespersons whom the client approved of, guidance of a message of the salesperson is image-displayed in accordance with the priority.

13. A marketing supporting method as recited in claim 12, wherein said displaying is such that guidance of a message of a salesperson whose priority is high is image-displayed while a message of a salesperson whose priority is low is displayed in a listed manner in accordance with an instruction from the client.

14. A marketing supporting method as recited in any one of claim 11 to claim 13, wherein said displaying is such that a message whose expiration date has passed is not displayed.

15. A marketing supporting method as recited in any one of claim 11 to claim 13, wherein said displaying is such that an image which guides a message from a salesperson is displayed by utilizing a personal image of the salesperson.

16. A marketing supporting method as recited in any one of claim 11 to claim 15, wherein said displaying is such that, when there is no unread messages from the salesperson, profile for the salesperson's company is image-displayed in place of message guidance.

17. A marketing supporting method as recited in any one of claim 11 to claim 15, further including, in the event that the guidance image is clicked by the client, displaying a message associated with the image.

18. A marketing supporting method as recited in any one of claim 11 to claim 16, further including, in the event that the guidance image is clicked by the customer, switching an accessing site of the client to a link site associated with the image so as to display information of the link site.

19. A marketing supporting method characterized in that it includes:
receiving an input of personal data of a client so as to be stored in a client table;
receiving an input of personal data of a salesperson so as to be stored in a salesperson table;
receiving identifying data of a salesperson in order for the client to approve the salesperson;
generating a selective registration table which, based on the identifying data that a client has inputted, associates the client table of said customer with the salesperson table of an approved salesperson;
registering entry of the customer into a client list file of the approved salesperson, on the occasion of said generating the selective registration table, so as to enable preparation of a message to said client; and
storing status of each message by unitarily managing messages that the salesperson sent to a plurality of clients registered in the client list file.

20. A marketing supporting method as recited in claim 19, further including:
notifying the salesperson about the status of the message; and
receiving from the salesperson a request that an unread message be canceled.

21. A marketing supporting method as recited in claim 19, further including, in the event that the salesperson requested that already read messages be canceled, refusing the cancellation request.

22. A marketing supporting method as recited in claim 19, further including suggesting an action that the salesperson should take for the client, based on the status.

23. A marketing supporting method as recited in claim 22, wherein said suggesting the action is such that a content of the action to be taken for the client is determined based on whether or not a message sent from the salesperson to the client is unread or the number of days elapsed after the client read the message when the message is already read.

24. A marketing supporting method as recited in claim 22, wherein said suggesting the action is such that a content of the action is determined based on, among a plurality of messages that the salesperson sent to the client, at least one of the number of messages in a state of being unread and the number of days elapsed after a most recent day when the client read a plurality of the messages.

25. A marketing supporting method as recited in claim 23 or claim 24, wherein said suggesting the action is such that a plurality of decision criteria for actions are set up in correspondence to importance levels of clients, and a content of the action is determined based on a decision criterion suited for an importance level.

26. A marketing supporting method further includes evaluating performance of the salesperson in accordance with status of contact with clients registered in the client list file.

27. A marketing supporting method as recited in claim 26, wherein said evaluating performance is such that performance of the salesperson is evaluated based on the number of clients registered in the client list file.

28. A marketing supporting method as recited in claim 26, wherein said evaluating performance is such that performance of the salesperson is evaluated based on the number of messages sent to clients registered in the client list file.

29. A marketing supporting method as recited in claim 26, wherein said evaluating performance is such that performance of the salesperson is evaluated based on a ratio at which messages sent to clients registered in the client list file are read by the clients.

30. A marketing supporting method as recited in any one of claim 26 to claim 29, wherein said storing status is such that the statuses of messages a plurality of salespersons sent to their own clients whom the plurality of salespersons are in charge of are unitarily managed, and said evaluating performance is such that performance of the plurality of salespersons is compared and evaluated.

31. A program characterized in that it causes a computer to execute the processes of:
receiving an input of personal data of a client so as to be stored in a client table;
receiving an input of personal data of a salesperson so as to be stored in a salesperson table;
receiving identifying data of a salesperson in order for the client to approve the salesperson;
generating a selective registration table which, based on the identifying data that a client has inputted, associates the client table of said client with the salesperson table of an approved salesperson; and
registering entry of the client into a client list file of the approved salesperson, on the occasion of said generating the selective registration table, so as to enable preparation of a message to said client.

32. A program characterized in that it causes a computer to execute the processes of:
receiving an input of personal data of a client so as to be stored in a client table;
receiving an input of personal data of a salesperson so as to be stored in a salesperson table;
receiving identifying data of a salesperson in order for the client to approve the salesperson;
generating a selective registration table which, based on the identifying data that a client has inputted, associates the client table of said client with the salesperson table of an approved salesperson;
registering entry of the client into a client list file of the approved salesperson, on the occasion of said generating the selective registration table, so as to enable preparation of a message to said client; and
supporting to compose a message to be sent to a client registered in the client list file by providing the salesperson with a formal library, prepared in advance, for use with business.

33. A program characterized in that it causes a computer to execute the processes of:
receiving an input of personal data of a client so as to be stored in a client table;
receiving an input of personal data of a salesperson so as to be stored in a salesperson table;
receiving identifying data of a salesperson in order for the client to approve the salesperson;
generating a selective registration table which, based on the identifying data that a client has inputted, associates the client table of said client with the salesperson table of an approved salesperson;
registering entry of the client into a client list file of the approved salesperson, on the occasion of said generating the selective registration table, so as to enable preparation of a message to said client; and
displaying an image which guides a message from a salesperson whom the client approved of, on a screen of a terminal of the client.

34. A program characterized in that it causes a computer to execute the processes of:
receiving an input of personal data of a client so as to be stored in a client table;
receiving an input of personal data of a salesperson so as to be stored in a salesperson table;
receiving identifying data of a salesperson in order for the client to approve the salesperson;
generating a selective registration table which, based on the identifying data that a client has inputted, associates the client table of said client with the salesperson table of an approved salesperson;
registering entry of the client into a client list file of the approved salesperson, on the occasion of said generating the selective registration table, so as to enable preparation of a message to said client; and
storing status of each message by unitarily managing messages that the salesperson sent to a plurality of clients registered in the customer list file.

35. A marketing supporting apparatus characterized in that it includes:
a client database which stores a client table that inputs personal data of a client;
a salesperson database which stores a salesperson table that inputs personal data of a salesperson and a selective registration table that associates the client table with the salesperson table;
a selective registration unit which receives, from a client, registration of identifying data of a salesperson whom said client approves;
a salesperson-side message interface which supports preparation of a message addressed to the client from the salesperson;
a message database which stores the message addressed to the client; and
a client-side message interface which provides the client with the message addressed to the client via a network, by reading out the message from said message database,
wherein, when the registration of the identifying data of the salesperson is received from the client, said selective registration unit generates and stores the selective registration table which associates the salesperson table of the salesperson identified by the identifying data with the client table of the client who performed the registration, and
said salesperson-side message interface, on the occasion of generation of the selective registration table, enables preparation of a message to the client who performed the registration.

36. A marketing supporting apparatus as recited in claim 35, wherein said message database is a single database structured such that the salesperson and the client can read and write messages by commonly accessing thereto via said salesperson-side message interface and said customer-side message interface, respectively.

37. A marketing supporting apparatus as recited in claim 35 or claim 36, wherein said message database is structured such that status of message by client is recorded in units of message, based on sender ID's and receiver ID's recorded in a header portion of message, and the salesperson can unitarily read messages belonging to a plurality of clients whom the salesperson himself/herself is in charge of, together with the status thereof.

38. A marketing supporting apparatus as recited in claim 35, wherein said salesperson-side message interface is such that in the selective registration table there is provided an entry into which a note regarding the client who performed the registration can be inputted and the table is supplied to the salesperson as a client list file of the salesperson.

39. A marketing supporting apparatus as recited in claim 38, wherein said selective registration unit receives from the client a request that registration of the salesperson be canceled, and said client managing unit deletes entry of the client who requested the cancellation, from the client list file.

40. A marketing supporting apparatus as recited in claim 38 or claim 39, wherein, as an entry for the note, there is provided an entry which sets importance of the client.

41. A marketing supporting apparatus as recited in claim 35, said salesperson-side message interface supports preparation of a guidance image displayed on a terminal of the client addressed, and receives from the salesperson an input of a catch phrase which appears in the image.

42. A marketing supporting apparatus as recited in claim 35, wherein said salesperson-side message interface supports preparation of a guidance image displayed on a terminal of the client addressed and receives setting of an personal image of the salesperson which appears in the image.

43. A marketing supporting apparatus as recited in claim 35, further including a formal library, used for a message addressed to a client, for use with business, wherein said salesperson-side message interface prepares a guidance image for the message displayed on a terminal of the client addressed, and supports preparing a message associated with the image by using the formal library.

44. A marketing supporting apparatus as recited in any one of claim 35 to claim 37, wherein said salesperson-side message interface receives setting of expiration date of the message from the salesperson, and sets a flag that disables a message whose expiration date has passed.

45. A marketing supporting apparatus as recited in any one of claim 41 to claim 44, wherein said salesperson-side message interface displays on a client terminal an image for guiding a message from the salesperson registered by the client.

46. A marketing supporting apparatus as recited in claim 45, wherein said client-side message interface receives, from the client, setting of priority of a plurality of salespersons whom the client registers, and image-displays guidance of a message of the salesperson in accordance with the priority.

47. A marketing supporting apparatus as recited in claim 45, wherein said client-side message interface image-displays guidance of a message of a salesperson whose priority is high while a message of a salesperson whose priority is low is displayed in a listed manner in accordance with an instruction from the client.

48. A marketing supporting apparatus as recited in claim 44, wherein said client-side message interface terminates display of a message to which a disabling flag is attached due to the fact that expiration date thereof has passed.

49. A marketing supporting apparatus as recited in claim 37, further including an action determining unit which suggests an action that the salesperson should take for the client, based on the status.

50. A marketing supporting apparatus as recited in claim 49, wherein said action determining unit determines a content of the action to be taken for the client based on whether or not a message sent from the salesperson to the client is unread or the number of days elapsed after the client read the message when the message is already read.

51. A marketing supporting apparatus as recited in claim 49, wherein said action determining unit determines a content of the action to be taken for the client based on, among a plurality of messages that the salesperson sent to the client, at least one of the number of messages in a state of being unread and the number of days elapsed after a most recent day when the client read a plurality of the messages.

52. A marketing supporting apparatus as recited in claim 50 or claim 51, wherein said action determining unit sets up a plurality of decision criteria for actions in correspondence to importance levels of clients, and determines a content of the action based on a decision criterion suited for an importance level.

53. A marketing supporting apparatus as recited in claim 38, further including a statistical analysis unit which evaluates performance of the salesperson in accordance with status of contact with clients registered in the client list file.

54. A marketing supporting apparatus as recited in claim 53, wherein said statistical analysis unit evaluates performance of the salesperson based on the number of clients registered in the client list file.

55. A marketing supporting apparatus as recited in claim 53, wherein said statistical analysis unit evaluates performance of the salesperson based on the number of messages sent to clients registered in the client list file.

56. A marketing supporting apparatus as recited in claim 53, wherein said statistical analysis unit evaluates performance of the salesperson based on a ratio at which messages sent to clients registered in the client list file are read by the clients.

57. A marketing supporting apparatus as recited in any one of claim 53 to claim 56, wherein said message database manages unitarily the status of messages that a plurality of salespersons sent to their own clients whom the plurality of salespersons are in charge of, and said statistical analysis unit compares and evaluates performance of the plurality of salespersons.
